(19) United States
(12) Patent Application Publication
(10) Pub. No.: US 2025/0294584 A1
(43) Pub. Date: Sep. 18, 2025

(54) METHOD AND DEVICE FOR SIDELINK TRANSMISSION OR RECEPTION IN WIRELESS COMMUNICATION SYSTEM

(71) Applicant: LG ELECTRONICS INC., Seoul (KR)

(72) Inventors: Seokmin SHIN, Seoul (KR); Suckchel YANG, Seoul (KR); Seungmin LEE, Seoul (KR); Daesung HWANG, Seoul (KR); Seonwook KIM, Seoul (KR)

(21) Appl. No.: 18/859,938

(22) PCT Filed: Mar. 30, 2023
(86) PCT No.: PCT/KR2023/004250

§ 371 Date: Oct. 24, 2024

(30) Foreign Application Priority Data
Apr. 28, 2022 (KR) 10-2022-0053067

(51) Int. Cl. H04W 72/25; H04L 5/00; H04W 74/0808

(52) U.S. Cl. CPC H04W 72/25; H04L 5/0055; H04W 74/0808

(57) ABSTRACT

A method and a device for sidelink transmission or reception in a wireless communication system are disclosed. A method performed in a shared spectrum according to an embodiment of the present disclosure may comprise the steps of: receiving configuration information related to a PSFCH; receiving SCI for scheduling a PSSCH; receiving the PSSCH on the basis of the SCI; and as a response to the PSSCH, transmitting the PSFCH including HARQ-ACK information.

### CROSS-REFERENCE TO RELATED APPLICATIONS

This application is the National Stage filing under 35 U.S.C. 371 of International Application No. PCT/KR2023/004250, filed on Mar. 30, 2023, which claims the benefit of earlier filing date and right of priority to Korean Application No. 10-2022-0053067, filed on Apr. 28, 2022, the contents of which are all incorporated by reference herein in their entireties.

### TECHNICAL FIELD

The present disclosure relates to a wireless communication system, and in more detail, relates to a method and an apparatus of sidelink transmission/reception in a wireless communication system.

### BACKGROUND

A mobile communication system has been developed to provide a voice service while guaranteeing mobility of users. However, a mobile communication system has extended even to a data service as well as a voice service, and currently, an explosive traffic increase has caused shortage of resources and users have demanded a faster service, so a more advanced mobile communication system has been required.

The requirements of a next-generation mobile communication system at large should be able to support accommodation of explosive data traffic, a remarkable increase in a transmission rate per user, accommodation of the significantly increased number of connected devices, very low End-to-End latency and high energy efficiency. To this end, a variety of technologies such as Dual Connectivity, Massive Multiple Input Multiple Output (Massive MIMO), In-band Full Duplex, Non-Orthogonal Multiple Access (NOMA), Super wideband Support, Device Networking, etc. have been researched.

### SUMMARY

A technical object of the present disclosure is to provide a method and an apparatus for sidelink transmission/reception in an unlicensed band/spectrum or shared spectrum.

In addition, an additional technical object of the present disclosure is to provide a method and an apparatus for transmitting and receiving a physical sidelink feedback channel (PSFCH) in an unlicensed band/spectrum or a shared spectrum.

In addition, an additional technical object of the present disclosure is to provide a method and an apparatus for determining slots and/or resources for PSFCH transmission and reception in an unlicensed band/spectrum or a shared spectrum.

The technical objects to be achieved by the present disclosure are not limited to the above-described technical objects, and other technical objects which are not described herein will be clearly understood by those skilled in the pertinent art from the following description.

A method performed in a shared spectrum by a user equipment (UE) in a wireless communication system according to an aspect of the present disclosure may include: receiving configuration information related to a physical sidelink feedback channel (PSFCH); receiving sidelink control information (SCI) for scheduling a physical sidelink shared channel (PSSCH); receiving the PSSCH based on the SCI; and transmitting the PSFCH including hybrid automatic repeat request (HARQ)-acknowledgement (ACK) information in response to the PSSCH. A slot for transmission of the PSFCH may be determined to be a second slot based on information in the SCI, based on a first slot determined based on the configuration information not being included in a channel occupancy time (COT) for sharing channel occupancy.

A method performed in a shared spectrum by a user equipment (UE) in a wireless communication system according to an additional aspect of the present disclosure may include: transmitting sidelink control information (SCI) for scheduling a physical sidelink shared channel (PSSCH); transmitting the PSSCH based on the SCI; and receiving a physical sidelink feedback channel (PSFCH) including hybrid automatic repeat request (HARQ)-acknowledgement (ACK) information in response to the PSSCH. A slot for transmission of the PSFCH may be determined to be a second slot based on information in the SCI, based on a first slot determined based on configuration information related to the PSFCH not being included in a channel occupancy time (COT) for sharing channel occupancy.

According to an embodiment of the present disclosure, sidelink transmission and reception can be supported in an unlicensed band/spectrum or a shared spectrum.

In addition, according to an embodiment of the present disclosure, when sidelink transmission and reception is performed in an unlicensed band/spectrum or a shared spectrum, a PSFCH can be stably transmitted and received.

In addition, according to an embodiment of the present when sidelink transmission and reception is performed in an unlicensed band/spectrum or a shared spectrum, an operation of additional channel access for PSFCH transmission can be excluded, so that faster PSFCH transmission and reception is possible.

Effects achievable by the present disclosure are not limited to the above-described effects, and other effects which are not described herein may be clearly understood by those skilled in the pertinent art from the following description.

### BRIEF DESCRIPTION OF THE DRAWINGS

Accompanying drawings included as part of detailed description for understanding the present disclosure provide embodiments of the present disclosure and describe technical features of the present disclosure with detailed description.

FIG. 1 illustrates a structure of a wireless communication system to which the present disclosure may be applied.

FIG. 2 illustrates a frame structure in a wireless communication system to which the present disclosure may be applied.

FIG. 3 illustrates a resource grid in a wireless communication system to which the present disclosure may be applied.

FIG. 4 illustrates a physical resource block in a wireless communication system to which the present disclosure may be applied.

FIG. 5 illustrates a slot structure in a wireless communication system to which the present disclosure may be applied.

FIG. 6 illustrates physical channels used in a wireless communication system to which the present disclosure may be applied and a general signal transmission and reception method using them.

FIG. 7 illustrates a procedure for performing V2X or SL communication according to a transmission mode in a wireless communication system to which the present disclosure may be applied.

FIG. 8 illustrates a cast type for V2X or SL communication in a wireless communication system to which the present disclosure may be applied.

FIG. 9 illustrates a method for determining a PSFCH slot in a wireless communication system to which the present disclosure can be applied.

FIG. 10 is a diagram illustrating resource mapping between PSSCH resources and PSFCH resources in a wireless communication system to which the present disclosure can be applied.

FIG. 11 is a diagram illustrating resource mapping between PSSCH resources and PSFCH resources according to an embodiment of the present disclosure.

FIG. 12 illustrates a signaling procedure for a PSFCH transmission and reception method according to an embodiment of the present disclosure.

FIG. 13 is a diagram illustrating an operation of a UE for a PSFCH transmission and reception method according to one embodiment of the present disclosure.

FIG. 14 is a diagram illustrating an operation of a UE for a PSFCH transmission and reception method according to one embodiment of the present disclosure.

FIG. 15 illustrates a block diagram of a wireless communication device according to an embodiment of the present disclosure.

### DETAILED DESCRIPTION

Hereinafter, embodiments according to the present disclosure will be described in detail by referring to accompanying drawings. Detailed description to be disclosed with accompanying drawings is to describe exemplary embodiments of the present disclosure and is not to represent the only embodiment that the present disclosure may be implemented. The following detailed description includes specific details to provide complete understanding of the present disclosure. However, those skilled in the pertinent art that the present disclosure may be implemented without such specific details.

In some cases, known structures and devices may be omitted or may be shown in a form of a block diagram based on a core function of each structure and device in order to prevent a concept of the present disclosure from being ambiguous.

In the present disclosure, when an element is referred to as being “connected”, “combined” or “linked” to another element, it may include an indirect connection relation that yet another element presents therebetween as well as a direct connection relation. In addition, in the present disclosure, a term, “include” or “have”, specifies the presence of a mentioned feature, step, operation, component and/or element, but it does not exclude the presence or addition of one or more other features, stages, operations, components, elements and/or their groups.

In the present disclosure, a term such as “first”, “second”, etc. is used only to distinguish one element from other element and is not used to limit elements, and unless otherwise specified, it does not limit an order or importance, etc. between elements. Accordingly, within a scope of the present disclosure, a first element in an embodiment may be referred to as a second element in another embodiment and likewise, a second element in an embodiment may be referred to as a first element in another embodiment.

A term used in the present disclosure is to describe a specific embodiment, and is not to limit a claim. As used in a described and attached claim of an embodiment, a singular form is intended to include a plural form, unless the context clearly indicates otherwise. A term used in the present disclosure, “and/or”, may refer to one of related enumerated items or it means that it refers to and includes any and all possible combinations of two or more of them. In addition, “/” between words in the present disclosure has the same meaning as “and/or”, unless otherwise described.

The present disclosure describes a wireless communication network or a wireless communication system, and an operation performed in a wireless communication network may be performed in a process in which a device (e.g., a base station) controlling a corresponding wireless communication network controls a network and transmits or receives a signal, or may be performed in a process in which a terminal associated to a corresponding wireless network transmits or receives a signal with a network or between terminals.

In the present disclosure, transmitting or receiving a channel includes a meaning of transmitting or receiving information or a signal through a corresponding channel. For example, transmitting a control channel means that control information or a control signal is transmitted through a control channel. Similarly, transmitting a data channel means that data information or a data signal is transmitted through a data channel.

Hereinafter, a downlink (DL) means a communication from a base station to a terminal and an uplink (UL) means a communication from a terminal to a base station. In a downlink, a transmitter may be part of a base station and a receiver may be part of a terminal. In an uplink, a transmitter may be part of a terminal and a receiver may be part of a base station. A base station may be expressed as a first communication device and a terminal may be expressed as a second communication device. A base station (BS) may be substituted with a term such as a fixed station, a Node B, an eNB (evolved-NodeB), a gNB (Next Generation NodeB), a BTS (base transceiver system), an Access Point (AP), a Network (5G network), an AI (Artificial Intelligence) system/module, an RSU (road side unit), a robot, a drone (UAV: Unmanned Aerial Vehicle), an AR (Augmented Reality) device, a VR (Virtual Reality) device, etc. In addition, a terminal may be fixed or mobile, and may be substituted with a term such as a UE (User Equipment), an MS (Mobile Station), a UT (user terminal), an MSS (Mobile Subscriber Station), an SS (Subscriber Station), an AMS (Advanced Mobile Station), a WT (Wireless terminal), an MTC (Machine-Type Communication) device, an M2M (Machine-to-Machine) device, a D2D (Device-to-Device) device, a vehicle, an RSU (road side unit), a robot, an AI (Artificial Intelligence) module, a drone (UAV: Unmanned Aerial Vehicle), an AR (Augmented Reality) device, a VR (Virtual Reality) device, etc.

The following description may be used for a variety of radio access systems such as CDMA, FDMA, TDMA, OFDMA, SC-FDMA, etc. CDMA may be implemented by a wireless technology such as UTRA (Universal Terrestrial Radio Access) or CDMA2000. TDMA may be implemented by a radio technology such as GSM (Global System for Mobile communications)/GPRS (General Packet Radio Service)/EDGE (Enhanced Data Rates for GSM Evolution). OFDMA may be implemented by a radio technology such as IEEE 802.11 (Wi-Fi), IEEE 802. 16 (WiMAX), IEEE 802-20, E-UTRA (Evolved UTRA), etc. UTRA is a part of a UMTS (Universal Mobile Telecommunications System). 3GPP (3rd Generation Partnership Project) LTE (Long Term Evolution) is a part of an E-UMTS (Evolved UMTS) using E-UTRA and LTE-A (Advanced)/LTE-A pro is an advanced version of 3GPP LTE. 3GPP NR (New Radio or New Radio Access Technology) is an advanced version of 3GPP LTE/LTE-A/LTE-A pro.

To clarify description, it is described based on a 3GPP communication system (e.g., LTE-A, NR), but a technical idea of the present disclosure is not limited thereto. LTE means a technology after 3GPP TS (Technical Specification) 36.xxx Release 8. In detail, an LTE technology in or after 3GPP TS 36. xxx Release 10 is referred to as LTE-A and an LTE technology in or after 3GPP TS 36. xxx Release 13 is referred to as LTE-A pro. 3GPP NR means a technology in or after TS 38. xxx Release 15. LTE/NR may be referred to as a 3GPP system. “xxx” means a detailed number for a standard document. LTE/NR may be commonly referred to as a 3GPP system. For a background art, a term, an abbreviation, etc. used to describe the present disclosure, matters described in a standard document disclosed before the present disclosure may be referred to. For example, the following document may be referred to.

For 3GPP LTE, TS 36. 211 (physical channels and modulation), TS 36.212 (multiplexing and channel coding), TS 36.213 (physical layer procedures), TS 36.300 (overall description), TS 36.331 (radio resource control) may be referred to.

For 3GPP NR, TS 38. 211 (physical channels and modulation), TS 38.212 (multiplexing and channel coding), TS 38.213 (physical layer procedures for control), TS 38.214 (physical layer procedures for data), TS 38.300 (NR and NG-RAN (New Generation-Radio Access Network) overall description), TS 38.331 (radio resource control protocol specification) may be referred to.

Abbreviations of terms which may be used in the present disclosure is defined as follows.
BM: beam management
CQI: Channel Quality Indicator
CRI: channel state information-reference signal resource indicator
CSI: channel state information
CSI-IM: channel state information-interference measurement
CSI-RS: channel state information-reference signal
DMRS: demodulation reference signal
FDM: frequency division multiplexing
FFT: fast Fourier transform
IFDMA: interleaved frequency division multiple access
IFFT: inverse fast Fourier transform
L1-RSRP: Layer 1 reference signal received power
L1-RSRQ: Layer 1 reference signal received quality
MAC: medium access control
NZP: non-zero power
OFDM: orthogonal frequency division multiplexing
PDCCH: physical downlink control channel
PDSCH: physical downlink shared channel
PMI: precoding matrix indicator
RE: resource element
RI: Rank indicator
RRC: radio resource control
RSSI: received signal strength indicator
Rx: Reception
QCL: quasi co-location
SINR: signal to interference and noise ratio
SSB (or SS/PBCH block): Synchronization signal block (including PSS (primary synchronization signal), SSS (secondary synchronization signal) and PBCH (physical broadcast channel))
TDM: time division multiplexing
TRP: transmission and reception point
TRS: tracking reference signal
Tx: transmission
UE: user equipment
ZP: zero power

### Overall System

As more communication devices have required a higher capacity, a need for an improved mobile broadband communication compared to the existing radio access technology (RAT) has emerged. In addition, massive MTC (Machine Type Communications) providing a variety of services anytime and anywhere by connecting a plurality of devices and things is also one of main issues which will be considered in a next-generation communication. Furthermore, a communication system design considering a service/a terminal sensitive to reliability and latency is also discussed. As such, introduction of a next-generation RAT considering eMBB (enhanced mobile broadband communication), mMTC (massive MTC), URLLC (Ultra-Reliable and Low Latency Communication), etc. is discussed and, for convenience, a corresponding technology is referred to as NR in the present disclosure. NR is an expression which represents an example of a 5G RAT.

A new RAT system including NR uses an OFDM transmission method or a transmission method similar to it. A new RAT system may follow OFDM parameters different from OFDM parameters of LTE. Alternatively, a new RAT system follows a numerology of the existing LTE/LTE-A as it is, but may support a wider system bandwidth (e.g., 100 MHz). Alternatively, one cell may support a plurality of numerologies. In other words, terminals which operate in accordance with different numerologies may coexist in one cell.

A numerology corresponds to one subcarrier spacing in a frequency domain. As a reference subcarrier spacing is scaled by an integer N, a different numerology may be defined.

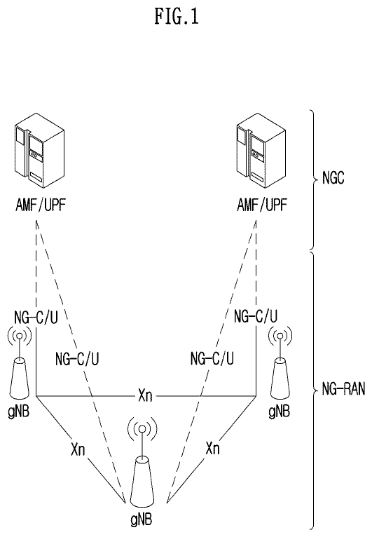

FIG. 1 illustrates a structure of a wireless communication system to which the present disclosure may be applied.

In reference to FIG. 1, NG-RAN is configured with gNBs which provide a control plane (RRC) protocol end for a NG-RA (NG-Radio Access) user plane (i.e., a new AS (access stratum) sublayer/PDCP (Packet Data Convergence Protocol)/RLC (Radio Link Control)/MAC/PHY) and UE. The gNBs are interconnected through a Xn interface. The gNB, in addition, is connected to an NGC (New Generation Core) through an NG interface. In more detail, the gNB is connected to an AMF (Access and Mobility Management Function) through an N2 interface, and is connected to a UPF (User Plane Function) through an N3 interface.

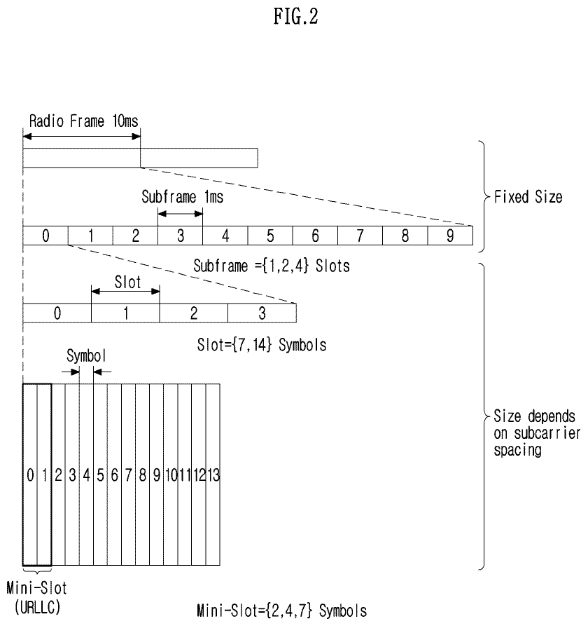

FIG. 2 illustrates a frame structure in a wireless communication system to which the present disclosure may be applied.

A NR system may support a plurality of numerologies. Here, a numerology may be defined by a subcarrier spacing and a cyclic prefix (CP) overhead. Here, a plurality of subcarrier spacings may be derived by scaling a basic (reference) subcarrier spacing by an integer N (or, u). In addition, although it is assumed that a very low subcarrier spacing is not used in a very high carrier frequency, a used numerology may be selected independently from a frequency band. In addition, a variety of frame structures according to a plurality of numerologies may be supported in a NR system.

Hereinafter, an OFDM numerology and frame structure which may be considered in a NR system will be described. A plurality of OFDM numerologies supported in a NR system may be defined as in the following Table 1.

TABLE 1

| μ | Δf = 2^{μ} · 15 [kHz] | CP |
|---|---|---|
| 0 | 15 | Normal |
| 1 | 30 | Normal |
| 2 | 60 | Normal, Extended |
| 3 | 120 | Normal |
| 4 | 240 | Normal |

NR supports a plurality of numerologies (or subcarrier spacings (SCS)) for supporting a variety of 5G services. For example, when a SCS is 15 kHz, a wide area in traditional cellular bands is supported, and when a SCS is 30 kHz/60 kHz, dense-urban, lower latency and a wider carrier bandwidth are supported, and when a SCS is 60 kHz or higher, a bandwidth wider than 24.25 GHz is supported to overcome a phase noise.

An NR frequency band is defined as a frequency range in two types (FR1, FR2). FR1, FR2 may be configured as in the following Table 2. In addition, FR2 may mean a millimeter wave (mmW).

TABLE 2

| Frequency Range | Corresponding | Subcarrier |
|---|---|---|
| designation | frequency range | Spacing |
| FR1 | 410 MHz-7125 MHz | 15, 30, 60 kHz |
| FR2 | 24250 MHz-52600 MHz | 60, 120, 240 kHz |

Regarding a frame structure in an NR system, a size of a variety of fields in a time domain is expresses as a multiple of a time unit of T_{c}=1/(Δfₘₐₓ·N_{f}). Here, Δfₘₐₓ is 480·103 Hz and N_{f} is 4096. Downlink and uplink transmission is configured (organized) with a radio frame having a duration of T_{f}=1/(ΔfₘₐₓN_{f}/100)·T_{c}=10 ms. Here, a radio frame is configured with 10 subframes having a duration of T_{sf}=(ΔfₘₐₓN_{f}/1000)·T_{c}=1 ms, respectively. In this case, there may be one set of frames for an uplink and one set of frames for a downlink. In addition, transmission in an uplink frame No. i from a terminal should start earlier by T_{TA}=(N_{TA}+N_{TA, offset}) T_{c} than a corresponding downlink frame in a corresponding terminal starts. For a subcarrier spacing configuration μ, slots are numbered in an increasing order of nₛ^{μ}∈{0, . . . , Nₛₗₒₜ^{subframe, μ}−1} in a subframe and are numbered in an increasing order of n_{s,f}^{μ}∈{0, . . . , Nₛₗₒₜ^{frame, μ}−1} in a radio frame. One slot is configured with N_{symb}^{slot} consecutive OFDM symbols and N_{symb}^{slot} is determined according to CP. A start of a slot nₛ^{μ} in a subframe is temporally arranged with a start of an OFDM symbol nₛ^{μ}N_{symb}^{slot} in the same subframe. All terminals may not perform transmission and reception at the same time, which means that all OFDM symbols of a downlink slot or an uplink slot may not be used.

Table 3 represents the number of OFDM symbols per slot (N_{symb}^{slot}), the number of slots per radio frame (Nₛₗₒₜ^{frame, μ}) and the number of slots per subframe (Nₛₗₒₜ^{subframe, μ}) in a normal CP and Table 4 represents the number of OFDM symbols per slot, the number of slots per radio frame and the number of slots per subframe in an extended CP.

TABLE 3

| μ | N_{symb}^{slot} | Nₛₗₒₜ^{frame, μ} | Nₛₗₒₜ^{subframe, μ} |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |

TABLE 4

| μ | N_{symb}^{slot} | Nₛₗₒₜ^{frame, μ} | Nₛₗₒₜ^{subframe, μ} |
|---|---|---|---|
| 2 | 12 | 40 | 4 |

FIG. 2 is an example on μ=2 (SCS is 60 kHz), 1 subframe may include 4 slots referring to Table 3. 1 subframe={1, 2, 4} slot shown in FIG. 2 is an example, the number of slots which may be included in 1 subframe is defined as in Table 3 or Table 4. In addition, a mini-slot may include 2, 4 or 7 symbols or more or less symbols.

Regarding a physical resource in a NR system, an antenna port, a resource grid, a resource element, a resource block, a carrier part, etc. may be considered. Hereinafter, the physical resources which may be considered in an NR system will be described in detail.

First, in relation to an antenna port, an antenna port is defined so that a channel where a symbol in an antenna port is carried can be inferred from a channel where other symbol in the same antenna port is carried. When a large-scale property of a channel where a symbol in one antenna port is carried may be inferred from a channel where a symbol in other antenna port is carried, it may be said that 2 antenna ports are in a QC/QCL (quasi co-located or quasi co-location) relationship. In this case, the large-scale property includes at least one of delay spread, doppler spread, frequency shift, average received power, received timing.

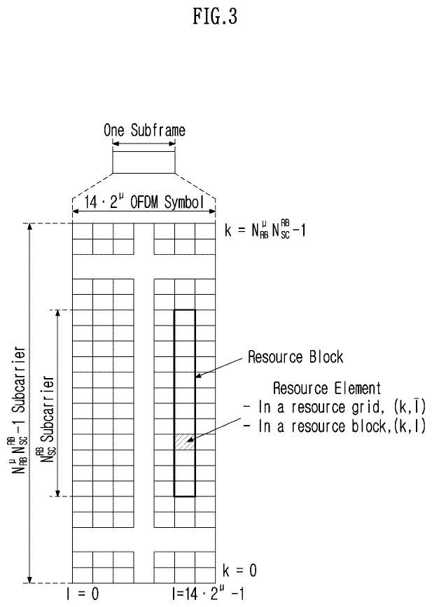

FIG. 3 illustrates a resource grid in a wireless communication system to which the present disclosure may be applied.

In reference e to FIG. it is illustratively described that a resource grid is configured with N_{RB}^{μ}N_{sc}^{RB} subcarriers in a frequency domain and one subframe is configured with 14·2^{μ} OFDM symbols, but it is not limited thereto. In an NR system, a transmitted signal is described by OFDM symbols of 2^{μ}N_{symb}^{(μ)} and one or more resource grids configured with N_{RB}^{μ}N_{sc}^{RB} subcarriers. Here, N_{RB}^{μ}≤N_{RB}^{max,μ}. The N_{RB}^{max,μ} represents a maximum transmission bandwidth, which may be different between an uplink and a downlink as well as between numerologies. In this case, one resource grid may be configured per μ and antenna port p. Each element of a resource grid for μ and an antenna port p is referred to as a resource element and is uniquely identified by an index pair (k, l′). Here, k=0, . . . , N_{RB}^{μ}N_{sc}^{RB}−1 is an index in a frequency domain and l′=0, . . . , 2^{μ}N_{symb}^{(μ)}−1 refers to a position of a symbol in a subframe. When referring to a resource element in a slot, an index pair (k, l) is used. Here, 1=0, . . . , N_{symb}^{μ}−1. A resource element (k, l′) for μ and an antenna port p corresponds to a complex value, a_{k,l′}^{(p,μ)}. When there is no risk of confusion or when a specific antenna port or numerology is not specified, indexes p and μ may be dropped, whereupon a complex value may be a_{k,l′}^{(p)} or a_{k,l′}. In addition, a resource block (RB) is defined as N_{sc}^{RB}=12 consecutive subcarriers in a frequency domain.

Point A plays a role as a common reference point of a resource block grid and is obtained as follows.
offsetToPointA for a primary cell (PCell) downlink represents a frequency offset between point A and the lowest subcarrier of the lowest resource block overlapped with a SS/PBCH block which is used by a terminal for an initial cell selection. It is expressed in resource block units assuming a 15 kHz subcarrier spacing for FR1 and a 60 kHz subcarrier spacing for FR2.
absoluteFrequencyPointA represents a frequency-position of point A expressed as in ARFCN (absolute radio-frequency channel number).

Common resource blocks are numbered from 0 to the top in a frequency domain for a subcarrier spacing configuration μ. The center of subcarrier 0 of common resource block 0 for a subcarrier spacing configuration μ is identical to ‘point A’. A relationship between a common resource block number n_{CRB}^{μ} and a resource element (k, l) for a subcarrier spacing configuration μ in a frequency domain is given as in the following Equation 1.

$${n}_{CRB}^{μ} = ⌊ \frac{k}{{N}_{sc}^{RB}} ⌋ \qquad [ Equation 1 ]$$

In Equation 1, k is defined relatively to point A so that k=0 corresponds to a subcarrier centering in point A. Physical resource blocks are numbered from 0 to N_{BWP,i}^{size,μ}−1 in a bandwidth part (BWP) and i is a number of a BWP. A relationship between a physical resource block n_{PRB} and a common resource block n_{CRB} in BWP i is given by the following Equation 2.

$${n}_{CRB}^{μ} = {n}_{PRB}^{μ} + {N}_{BWP , i}^{start , μ} \qquad [ Equation 2 ]$$

N_{BWP,i}^{start, μ} is a common resource block that a BWP starts relatively to common resource block 0.

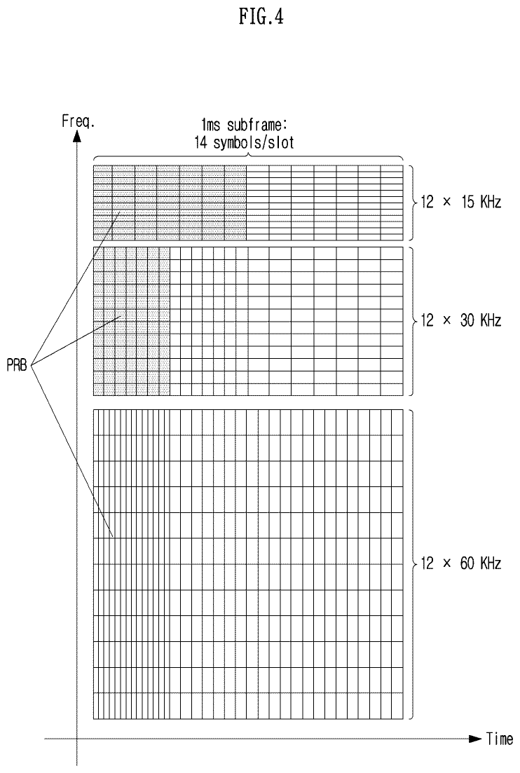

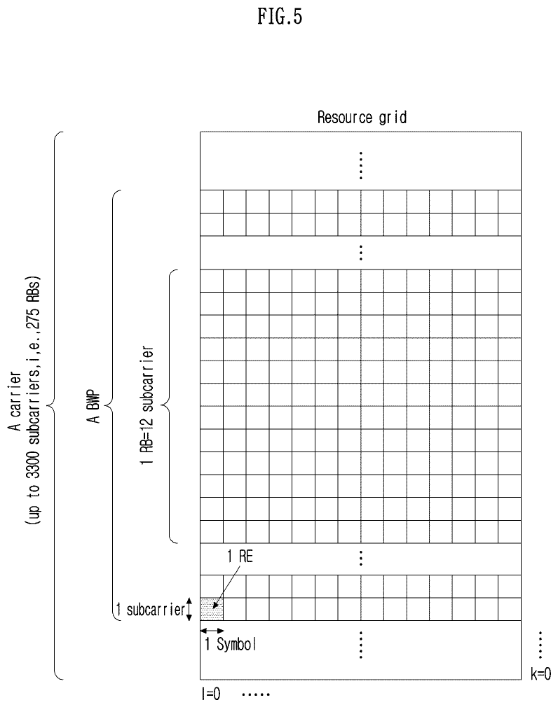

FIG. 4 illustrates a physical resource block in a wireless communication system to which the present disclosure may be applied. And, FIG. 5 illustrates a slot structure in a wireless communication system to which the present disclosure may be applied.

In reference to FIG. 4 and FIG. 5, a slot includes a plurality of symbols in a time domain. For example, for a normal CP, one slot includes 7 symbols, but for an extended CP, one slot includes 6 symbols.

A carrier includes a plurality of subcarriers in a frequency domain. An RB (Resource Block) is defined as a plurality of (e.g., 12) consecutive subcarriers in a frequency domain. A BWP (Bandwidth Part) is defined as a plurality of consecutive (physical) resource blocks in a frequency domain and may correspond to one numerology (e.g., an SCS, a CP length, etc.). A carrier may include a maximum N (e.g., 5) BWPs. A data communication may be performed through an activated BWP and only one BWP may be activated for one terminal. In a resource grid, each element is referred to as a resource element (RE) and one complex symbol may be mapped.

In an NR system, up to 400 MHZ may be supported per component carrier (CC). If a terminal operating in such a wideband CC always operates turning on a radio frequency (FR) chip for the whole CC, terminal battery consumption may increase. Alternatively, when several application cases operating in one wideband CC (e.g., eMBB, URLLC, Mmtc, V2X, etc.) are considered, a different numerology (e.g., a subcarrier spacing, etc.) may be supported per frequency band in a corresponding CC. Alternatively, each terminal may have a different capability for the maximum bandwidth. By considering it, a base station may indicate a terminal to operate only in a partial bandwidth, not in a full bandwidth of a wideband CC, and a corresponding partial bandwidth is defined as a bandwidth part (BWP) for convenience. A BWP may be configured with consecutive RBs on a frequency axis and may correspond to one numerology (e.g., a subcarrier spacing, a CP length, a slot/a mini-slot duration).

Meanwhile, a base station may configure a plurality of BWPs even in one CC configured to a terminal. For example, a BWP occupying a relatively small frequency domain may be configured in a PDCCH monitoring slot, and a PDSCH indicated by a PDCCH may be scheduled in a greater BWP. Alternatively, when UEs are congested in a specific BWP, some terminals may be configured with other BWP for load balancing. Alternatively, considering frequency domain inter-cell interference cancellation between neighboring cells, etc., some middle spectrums of a full bandwidth may be excluded and BWPs on both edges may be configured in the same slot. In other words, a base station may configure at least one DL/UL BWP to a terminal associated with a wideband CC. A base station may activate at least one DL/UL BWP of configured DL/UL BWP(s) at a specific time (by L1 signaling or MAC CE (Control Element) or RRC signaling, etc.). In addition, a base station may indicate switching to other configured DL/UL BWP (by L1 signaling or MAC CE or RRC signaling, etc.). Alternatively, based on a timer, when a timer value is expired, it may be switched to a determined DL/UL BWP. Here, an activated DL/UL BWP is defined as an active DL/UL BWP. But, a configuration on a DL/UL BWP may not be received when a terminal performs an initial access procedure or before a RRC connection is set up, so a DL/UL BWP which is assumed by a terminal under these situations is defined as an initial active DL/UL BWP.

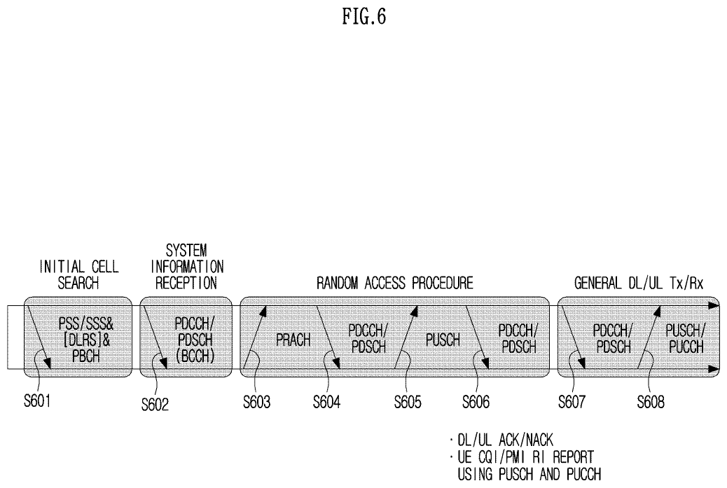

FIG. 6 illustrates physical channels used in a wireless communication system to which the present disclosure may be applied and a general signal transmission and reception method using them.

a wireless communication system, In a terminal receives information through a downlink from a base station and transmits information through an uplink to a base station. Information transmitted and received by a base station and a terminal includes data and a variety of control information and a variety of physical channels exist according to a type/a usage of information transmitted and received by them.

When a terminal is turned on or newly enters a cell, it performs an initial cell search including synchronization with a base station or the like (S601). For the initial cell search, a terminal may synchronize with a base station by receiving a primary synchronization signal (PSS) and a secondary synchronization signal (SSS) from a base station and obtain information such as a cell identifier (ID), etc. After that, a terminal may obtain broadcasting information in a cell by receiving a physical broadcast channel (PBCH) from a base station. Meanwhile, a terminal may check out a downlink channel state by receiving a downlink reference signal (DL RS) at an initial cell search stage.

A terminal which completed an initial cell search may obtain more detailed system information by receiving a physical downlink control channel (PDCCH) and a physical downlink shared channel (PDSCH) according to information carried in the PDCCH (S602).

Meanwhile, when a terminal accesses to a base station for the first time or does not have a radio resource for signal transmission, it may perform a random access (RACH) procedure to a base station (S603 to S606). For the random access procedure, a terminal may transmit a specific sequence as a preamble through a physical random access channel (PRACH) (S603 and S605) and may receive a response message for a preamble through a PDCCH and a corresponding PDSCH (S604 and S606). A contention based RACH may additionally perform a contention resolution procedure.

A terminal which performed the above-described procedure subsequently may perform PDCCH/PDSCH reception (S607) and PUSCH (Physical Uplink Shared Channel)/PUCCH (physical uplink control channel) transmission (S608) as a general uplink/downlink signal transmission procedure. In particular, a terminal receives downlink control information (DCI) through a PDCCH. Here, DCI includes control information such as resource allocation information for a terminal and a format varies depending on its purpose of use.

Meanwhile, control information which is transmitted by a terminal to a base station through an uplink or is received by a terminal from a base station includes a downlink/uplink ACK/NACK (Acknowledgement/Non-Acknowledgement) signal, a CQI (Channel Quality Indicator), a PMI (Precoding Matrix Indicator), a RI (Rank Indicator), etc. For a 3GPP LTE system, a terminal may transmit control information of the above-described CQI/PMI/RI, etc. through a PUSCH and/or a PUCCH.

Table 5 represents an example of a DCI format in an NR system.

TABLE 5

| DCI | |
|---|---|
| Format | Use |
| 0_0 | Scheduling of a PUSCH in one cell |
| 0_1 | Scheduling of one or multiple PUSCHs in one cell, or indication |
| | of cell group downlink feedback information to a UE |
| 0_2 | Scheduling of a PUSCH in one cell |
| 1_0 | Scheduling of a PDSCH in one DL cell |
| 1_1 | Scheduling of a PDSCH in one cell |
| 1_2 | Scheduling of a PDSCH in one cell |

In reference to Table 5, DCI formats 0_0, 0_1 and 0_2 may include resource information (e.g., UL/SUL (Supplementary UL), frequency resource allocation, time resource allocation, frequency hopping, etc.), information related to a transport block (TB) (e.g., MCS (Modulation Coding and Scheme), a NDI (New Data Indicator), a RV (Redundancy Version), etc.), information related to a HARQ (Hybrid-Automatic Repeat and request) (e.g., a process number, a DAI (Downlink Assignment Index), PDSCH-HARQ feedback timing, etc.), information related to multiple antennas (e.g., DMRS sequence initialization information, an antenna port, a CSI request, etc.), power control information (e.g., PUSCH power control, etc.) related to scheduling of a PUSCH and control information included in each DCI format may be pre-defined.

DCI format 0_0 is used for scheduling of a PUSCH in one cell. Information included in DCI format 0_0 is CRC (cyclic redundancy check) scrambled by a C-RNTI (Cell Radio Network Temporary Identifier) or a CS-RNTI (Configured Scheduling RNTI) or a MCS-C-RNTI (Modulation Coding Scheme Cell RNTI) and transmitted.

DCI format 0_1 is used to indicate scheduling of one or more PUSCHs or configure grant (CG) downlink feedback information to a terminal in one cell. Information included in DCI format 0_1 is CRC scrambled by a C-RNTI or a CS-RNTI or a SP-CSI-RNTI (Semi-Persistent CSI RNTI) or a MCS-C-RNTI and transmitted.

DCI format 0_2 is used for scheduling of a PUSCH in one cell. Information included in DCI format 0_2 is CRC scrambled by a C-RNTI or a CS-RNTI or a SP-CSI-RNTI or a MCS-C-RNTI and transmitted.

Next, DCI formats 1_0, 1_1 and 1_2 may include resource information (e.g., frequency resource allocation, time resource allocation, VRB (virtual resource block)-PRB (physical resource block) mapping, etc.), information related to a transport block (TB) (e.g., MCS, NDI, RV, etc.), information related to a HARQ (e.g., a process number, DAI, PDSCH-HARQ feedback timing, etc.), information related to multiple antennas (e.g., an antenna port, a TCI (transmission configuration indicator), a SRS (sounding reference signal) request, etc.), information related to a PUCCH (e.g., PUCCH power control, a PUCCH resource indicator, etc.) related to scheduling of a PDSCH and control information included in each DCI format may be pre-defined.

DCI format 1_0 is used for scheduling of a PDSCH in one DL cell. Information included in DCI format 1_0 is CRC scrambled by a C-RNTI or a CS-RNTI or a MCS-C-RNTI and transmitted.

DCI format 1_1 is used for scheduling of a PDSCH in one cell. Information included in DCI format 1_1 is CRC scrambled by a C-RNTI or a CS-RNTI or a MCS-C-RNTI and transmitted.

DCI format 1_2 is used for scheduling of a PDSCH in one cell. Information included in DCI format 1_2 is CRC scrambled by a C-RNTI or a CS-RNTI or a MCS-C-RNTI and transmitted.

### V2X (Vehicle-to-Everything)/Side Link (SL: Sidelink) Communication

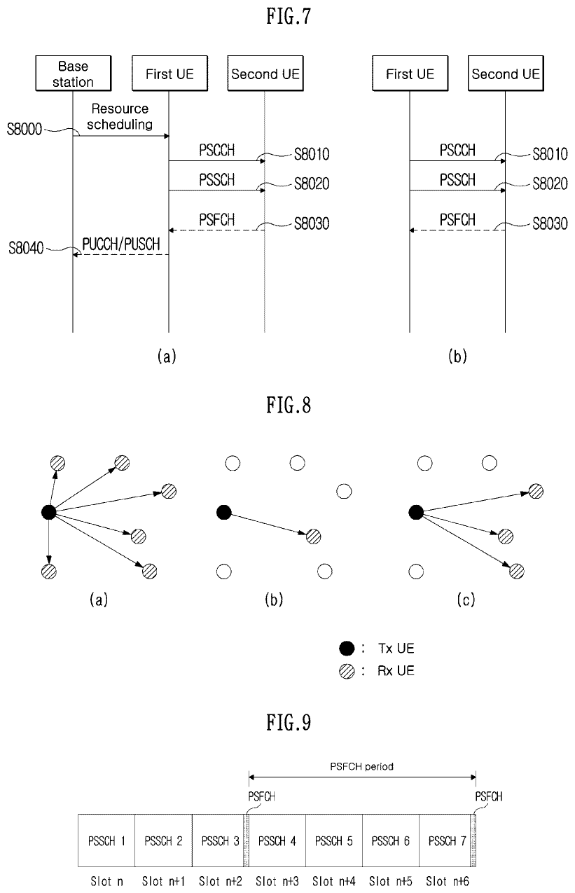

FIG. 7 illustrates a procedure for performing V2X or SL communication according to a transmission mode in a wireless communication system to which the present disclosure may be applied.

The embodiment of FIG. 7 may be combined with various embodiments of the present disclosure. In various embodiments of the present disclosure, the transmission mode may be referred to as a mode or a resource allocation mode. Hereinafter, for convenience of explanation, the transmission mode in LTE may be referred to as an LTE transmission mode, and the transmission mode in NR may be referred to as an NR resource allocation mode.

For example, FIG. 7(a) illustrates the operation of a UE related to LTE transmission mode 1 or LTE transmission mode 3. Alternatively, for example, FIG. 7(a) illustrates the operation of a UE related to NR resource allocation mode 1. For example, LTE transmission mode 1 may be applied to general SL communication, and LTE transmission mode 3 may be applied to V2X communication.

For example, FIG. 7(b) illustrates the operation of a UE associated with LTE transmission mode 2 or LTE transmission mode 4. Alternatively, for example, FIG. 7(b) illustrates the operation of a UE associated with NR resource allocation mode 2.

Referring to FIG. 7(a), in LTE transmission mode 1, LTE transmission mode 3, or NR resource allocation mode 1, the base station may schedule SL resources to be used by the UE for SL transmission (S8000). For example, the base station may transmit information related to SL resources and/or information related to UL resources to the first UE. For example, the UL resources may include PUCCH resources and/or PUSCH resources. For example, the UL resources may be resources for reporting SL HARQ feedback to the base station.

For example, the first UE may receive information related to a dynamic grant (DG) resource and/or information related to a configured grant (CG) resource from the base station. For example, the CG resource may include a CG type 1 resource or a CG type 2 resource. In the present disclosure, the DG resource may be a resource that the base station configures/allocates to the first UE via DCI. In the present disclosure, the CG resource may be a (periodic) resource that the base station configures/allocates to the first UE via DCI and/or an RRC message. For example, in the case of a CG type 1 resource, the base station may transmit an RRC message including information related to the CG resource to the first UE. For example, in the case of a CG type 2 resource, the base station may transmit an RRC message including information related to the CG resource to the first UE, and the base station may transmit DCI related to activation or release of the CG resource to the first UE.

The first UE may transmit PSCCH (physical sidelink control channel) (e.g., Sidelink Control Information (SCI) or 1st-stage SCI) to the second UE based on the resource scheduling (S8010).

The first UE may transmit a PSSCH (physical sidelink shared channel) (e.g., a 2nd-stage SCI, a MAC protocol data unit (PDU), data, etc.) related to the PSCCH to the second UE (S8020).

The first UE may receive a PSFCH (physical sidelink feedback channel) related to the PSCCH/PSSCH from the second UE (S8030). For example, HARQ feedback information (e.g., NACK information or ACK information) can be received from the second UE via the PSFCH.

The first UE may transmit/report HARQ feedback information to the base station via PUCCH or PUSCH (S8040). For example, the HARQ feedback information reported to the base station may be information generated by the first UE based on HARQ feedback information received from the second UE. For example, the HARQ feedback information reported to the base station may be information generated by the first UE based on a rule set in advance. For example, the DCI may be DCI for scheduling of SL. For example, the format of the DCI may be DCI format 3_0 or DCI format 3_1.

Referring to FIG. 7(b), in LTE transmission mode 2, LTE transmission mode 4 or NR resource allocation mode 2, the UE may determine SL transmission resources within SL resources set by the base station/network or preset SL resources. For example, the set SL resources or preconfigured SL resources may be a resource pool. For example, the UE may autonomously select or schedule resources for SL transmission. For example, the UE may perform SL communication by selecting resources by itself within the configured resource pool. For example, the UE may perform sensing and resource (re) selection procedures to select resources by itself within a selection window. For example, the sensing may be performed on a sub-channel basis.

A first UE that has selected a resource within a resource pool may transmit a PSCCH (e.g., SCI or 1st-stage SCI) to a second UE using the resource (S8010).

The first UE may transmit a PSSCH (e.g., 2nd-stage SCI, MAC PDU, data, etc.) related to the PSCCH to the second UE (S8020).

The first UE may receive a PSFCH related to PSCCH/PSSCH from the second UE (S8030).

Referring to FIG. 7(a) or FIG. 7(b), for example, a first UE may transmit an SCI to a second UE on a PSCCH. Or, for example, the first UE may transmit two consecutive SCIs (e.g., 2-stage SCIs) to the second UE on the PSCCH and/or the PSSCH. In this case, the second UE may decode the two consecutive SCIs (e.g., 2-stage SCIs) to receive the PSSCH from the first UE. In the present disclosure, the SCI transmitted on the PSCCH may be referred to as a first (1st) SCI, a first SCI, a first-stage SCI, or a 1st-stage SCI format, and the SCI transmitted on the PSSCH may be referred to as a second (2nd) SCI, a second SCI, a second-stage SCI, or a 2nd-stage SCI format. For example, a 1st-stage SCI format may include SCI format 1-A, and a 2nd-stage SCI format may include SCI format 2-A and/or SCI format 2-B.

Referring to FIG. 7(a) or FIG. 7(b), in step S8030, the first UE may receive the PSFCH based on the description to be described below. For example, the first UE and the second UE may determine the PSFCH resource based on the description to be described below, and the second UE may transmit the HARQ feedback to the first UE using the PSFCH resource.

Describes the UE procedure for reporting HARQ-ACK on sidelink as specified in TS 38.213.

The UE may be indicated to transmit a PSFCH including HARQ-ACK information in response to the PSSCH reception by the SCI format scheduling the PSSCH reception. The UE provides HARQ-ACK information including ACK or NACK or only NACK.

The UE may be provided with a number of slots within the resource pool during a period of PSFCH transmission occasion resources by sl-PSFCH-Period. If the number of slots is 0, the PSFCH transmission of the UE within the resource pool is disabled.

The UE expects that slot t′ₖ^{SL} (0≤k<T″ₘₐₓ) includes PSFCH transmission occasion resources if k mod N_{PSSCH}^{PSFCH}=0, where t′ₖ^{SL} is defined in TS 38.214, T′ₘₐₓ is the number of slots belonging to the resource pool within 10240 msec according to TS 38.214, and N_{PSSCH}^{PSFCH} is provided by sl-PSFCH-Period.

The UE may be indicated by higher layers not to transmit a PSFCH containing HARQ-ACK information in response to receiving a PSSCH.

When a UE receives a PSSCH from a resource pool and the HARQ feedback enabled/disabled indicator field of the associated SCI format 2-A/2-B/2-C has value 1, the UE provides HARQ-ACK information in a PSFCH transmission from the resource pool. The UE transmits the PSFCH in the first slot that includes PSFCH resources and that corresponds to at least a number of slots provided by sl-MinTimeGapPSFCH of the resource pool after the last slot of the PSSCH reception.

The UE may be provided with a set of M_{PRB,set}^{PSFCH} PRBS in the resource pool for PSFCH transmission including HARQ-ACK information in the physical resource block (PRB) of the resource pool by sl-PSFCH-RB-Set. The UE may be provided with a set of M_{PRB,set}^{PSECH} PRBs in the resource pool by sl-RB-SetPSFCH for PSFCH transmission including conflict information in the PRB of the resource pool. The UE expects that different PRBs are (pre-) set for conflict information and HARQ-ACK information. For the number of N_{SUBCH} sub-channels for the resource pool provided by sl-NumSubchannel and the number of PSSCH slots associated with PSFCH slots less than or equal to N_{PSSCH}^{PSFCH}, the UE allocates [(i+j N_{PSSCH}^{PSFCH}) M_{subch,slot}^{,PSFCH} (i+1+j N_{PSSCH}^{PSFCH}) M_{subch,slot}^{PSFCH}−1] PRBS from M_{PRB,set}^{PSFCH} PRBs among the PSFCH slots and PSSCH slots associated with sub-channel j to slot i. Here, M_{subch,slot}^{PSFCH}=M_{PRB,set}^{PSFCH}/(N_{subch} N_{PSSCH}^{PSFCH}), 0≤i<N_{PSSCH}^{PSFCH}, 0≤j<N_{subch}, and the allocation starts in ascending order of i and continues in ascending order of j. The UE expects M_{PRB,set}^{PSFCH} to be a multiple of N_{subch}·N_{PSSCH}^{PSFCH}.

The UE determines the number of available PSFCH resources for multiplexing HARQ-ACK or conflict information in PSFCH transmission based on the indication by sl-PSFCH-CandidateResourceType as R_{PRB,CS}^{PSFCH}=N_{type}^{PSFCH}·M_{subch,slot}^{PSFCH}·N_{CS}^{PSFCH}, where N_{CS}^{PSFCH} is the number of cyclic shift pairs for the resource pool provided by sl-NumMuxCS-Pair.
When sl-PSFCH-CandidateResourceType is set to start SubCH, N_{type}^{PSFCH}=1, and M_{subch,slot}^{PSFCH} PRBs are associated with the start sub-channel of the corresponding PSSCH.
When sl-PSFCH-CandidateResourceType is set to allocSubCH, N_{type}^{PSFCH}=N_{subch}^{PSSCH}, and N_{subch}^{PSSCH}·M_{subch,slot}^{PSFCH} PRBs are associated with N_{subch}^{PSSCH} sub-channels of the corresponding PSSCH.
For conflict information, the corresponding PSSCH is determined based on sl-PSFCH-Occasion.

PSFCH resources are from first indexed N_{type}^{PSFCH}·M_{subch,slot}^{PSFCH} PRBs in ascending order of PRB index, and then from N_{CS}^{PSFCH} cyclic shift pairs in ascending order of cyclic shift pair index.

The UE determines the index of the PSFCH resource for transmitting the PSFCH including HARQ-ACK information or conflict information in response to the PSSCH reception, which corresponds to the reserved resource, as (P_{ID}+M_{ID}) mod_{RPRB,CS}^{PSFCH}. Here, P_{ID} is a physical layer source identifier provided by SCI format 2-A/2-B/2-C that schedules PSSCH reception or SCI format 2-A/2-B/2-C that reserves resources for conflict information to be provided from other UEs. For HARQ-ACK information, if the UE detects SCI format 2-A having a cast type indicator field value of “01”, M_{ID} is an identifier of the UE that receives the PSSCH indicated by the upper layer, otherwise MID is 0. For conflict information, M_{ID} is 0.

For PSFCH transmission including HARQ-ACK information or conflict information, the UE determines the value m₀ from the cyclic shift pair index corresponding to the PSFCH resource index and from N_{CS}^{PSFCH} using Table 6 below to calculate the value x of the cyclic shift.

Table 6 illustrates a set of cyclic shift pairs.

TABLE 6

| | m₀ | | | | | |
|---|---|---|---|---|---|---|
| | Cyclic | Cyclic | Cyclic | Cyclic | Cyclic | Cyclic |
| | shift | shift | shift | shift | shift | shift |
| | pair | pair | pair | pair | pair | pair |
| N_{CS}^{PSFCH} | index 0 | index 1 | index 2 | index 3 | index 4 | index 5 |
| 1 | 0 | — | — | — | — | — |
| 2 | 0 | 3 | — | — | — | — |
| 3 | 0 | 2 | 4 | — | — | — |
| 6 | 0 | 1 | 2 | 3 | 4 | 5 |

For PSFCH transmission including HARQ-ACK information, the UE determines a m_{cs} value as shown in Table 7 below if the UE detects an SCI format 2-A or SCI format 2-C having a cast type indicator field value of “01” or “10” to calculate the value a of the cyclic shift, and determines an m_{cs} value as shown in Table 8 below if the UE detects an SCI format 2-B or 2-A having a cast type indicator field value of “11”. For PSFCH transmission including conflict information, the UE determines an m_{cs} value as shown in Table 9 below to calculate the value α of the cyclic shift. The UE applies one cyclic shift from a cyclic shift pair to a sequence used for PSFCH transmission.

Table 7 illustrates the mapping of cyclic shifts of a sequence for PSFCH transmission from a cyclic shift pair and HARQ-ACK information bit values when the HARQ-ACK information includes ACK or NACK.

TABLE 7

| HARQ-ACK value | 0 (NACK) | 1 (ACK) |
|---|---|---|
| Sequency cyclic shift | 0 | 6 |

Table 8 illustrates the mapping of cyclic shifts of a sequence for PSFCH transmission from a cyclic shift pair and HARQ-ACK information bit values when HARQ-ACK information contains only NACK.

TABLE 8

| HARQ-ACK value | 0 (NACK) | 1 (ACK) |
|---|---|---|
| Sequency cyclic shift | 0 | N/A |

Table 9 illustrates the mapping of the cyclic shift of a sequence for PSFCH transmission and the value of the conflict information bit from a cyclic shift pair.

TABLE 9

| | Conflict information for the next |
|---|---|
| Conflict information | time-reserved resource within SCI |
| Sequence cyclic shift | 0 |

FIG. 8 illustrates a cast type for V2X or SL communication in a wireless communication system to which the present disclosure may be applied.

The embodiment of FIG. 8 may be combined with various embodiments of the present disclosure.

Referring to FIG. 8, FIG. 8(a) represents a broadcast type SL communication, FIG. 8(b) represents a unicast type SL communication, and FIG. 8(c) represents a group-cast type SL communication. In the case of a unicast type SL communication, a UE can perform one-to-one communication with another UE. In the case of a group-cast type SL communication, a UE may perform SL communication with one or more UEs within the group to which it belongs. In various embodiments of the present disclosure, SL group-cast communication may be referred to as SL multicast communication, SL one-to-many communication, etc.

Hereinafter, the HARQ (Hybrid Automatic Repeat Request) procedure is described.

For example, SL HARQ feedback may be enabled for unicast. In this case, in non-Code Block Group (CBG) operation, if a receiving UE decodes a PSCCH targeting the receiving UE and the receiving UE successfully decodes a transport block associated with the PSCCH, the receiving UE may generate an ACK. Then, the receiving UE may transmit the HARQ-ACK to the transmitting UE. On the other hand, if the receiving UE fails to successfully decode a transport block associated with the PSCCH after the receiving UE decodes the PSCCH targeting the receiving UE, the receiving UE may generate a NACK. Then, the receiving UE may transmit the NACK to the transmitting UE.

Also, for example, SL HARQ feedback may be enabled for group-cast. For example, in non-CBG operation, two HARQ feedback options may be supported for group-cast.
(1) group-cast option 1: If the receiving UE fails to decode a transport associated with the PSCCH after the receiving UE decodes the PSCCH targeting the receiving UE, the receiving UE may transmit a NACK to the transmitting UE via the PSFCH. On the other hand, if the receiving UE decodes the PSCCH targeting the receiving UE and the receiving UE successfully decodes the transport block associated with the PSCCH, the receiving UE may not transmit an ACK to the transmitting UE.
(2) Group-cast option 2: If the receiving UE fails to decode a transport block associated with the PSCCH after the receiving UE decodes the PSCCH targeting the receiving UE, the receiving UE may transmit a NACK to the transmitting UE via the PSFCH. Then, if the receiving UE decodes the PSCCH targeting the receiving UE and the receiving UE successfully decodes the transport block associated with the PSCCH, the receiving UE may transmit an ACK to the transmitting UE via the PSFCH.

For example, if group-cast option 1 is used for SL HARQ feedback, all UEs performing group-cast communication may share PSFCH resources. For example, UEs belonging to the same group may transmit HARQ feedback using the same PSFCH resources.

For example, if group-cast option 2 is used for SL HARQ feedback, each UE performing group-cast communication may use different PSFCH resources for HARQ feedback transmission. For example, UEs belonging to the same group may transmit HARQ feedback using different PSFCH resources.

In the present disclosure, ACK may be referred to as HARQ-ACK, ACK information, or positive-ACK information, and NACK may be referred to as HARQ-NACK, NACK information, or negative-ACK information.

### Operations in Unlicensed Band/Spectrum or Shared Spectrum

In next wireless system, UE may perform a sidelink transmission and/or reception in unlicensed band/spectrum or shared spectrum.

Meanwhile, for operations in unlicensed band, according to regulations or requirements for each band, a channel sensing operation (e.g., energy detection/measurement) for a channel to be used may be performed before performing transmission of UE.

Accordingly, UE may perform a transmission in the unlicensed band only if a channel or an RB set to be used is determined as IDLE (e.g., measured energy is not greater than or is less than a specific threshold) according to the result of the channel sensing. Alternatively, if a channel or an RB set to be used is determined as BUSY (e.g., measured energy is not less than or is greater than a specific threshold), a UE may cancel all or a part of a transmission in the unlicensed band. Here, according to the regulations or requirements for a transmission in the unlicensed band, a channel or an RB set may be determined as IDLE or BUSY based on whether each of a time period of signal/channel transmitted by the UE and/or a size of a frequency occupancy region and/or power spectral density (PSD) is equal to or greater than a certain level.

Meanwhile, in the operation in the unlicensed band, after transmission for a specific time period of the UE, for a certain period of time, the channel sensing operation may be omitted or simplified (with a relatively small channel sensing period). On the other hand, after a certain period of time has passed after the transmission, whether to perform a transmission may be determined after performing a normal channel sensing operation. In addition, in the unlicensed band, for simplifying channel sensing, it may be notified through channel occupancy time (COT) interval information that a channel obtained through initial normal channel sensing will be occupied for a certain period of time, and the length of the COT interval may be set to a different maximum value depending on the priority value of the service or data packet.

A base station may share the COT interval obtained through its channel sensing in the form of DCI transmission, and the UE may perform a specific (indicated) channel sensing type and/or cyclic prefix (CP) extension within the COT interval according to the DCI information received from the base station. In addition, the UE may share the COT interval obtained through its channel sensing with the base station that is the receiving target of the UL transmission of the UE, and the related information may be provided through UL through configured grant-uplink control information (CG-UCI). In the above situation, the base station may perform simplified channel sensing within the COT interval shared from the UE.

### Feedback Transmission Method for Sidelink Transmission in Unlicensed Band/Spectrum or Shared Spectrum

If sidelink transmission is performed in unlicensed band/spectrum (or shared spectrum), a PSFCH having an interlaced structure can be introduced by reusing interlaced PUCCH format 0 introduced in existing NR-U (NR unlicensed band).

For example, if a PSFCH has an interlaced structure, based on a single UL RB set (i.e., 20 MHZ), an interval between PRBs of a specific interlace is separated by 10 PRBs in 15 kHz SCS, and a total of 10 interlace indices can be occupied. For example, interlaced RBs within interlace index 0 can be {RB 0, RB 10, RB 20, . . . }, interlaced RBs within interlace index 1 can be {RB 1, RB 11, RB 21, . . . }, . . . interlaced RBs within interlace index 9 can be {RB 9, RB 19, RB 29, . . . }.

In addition, based on a single UL RB set (i.e., 20 MHz), in 30 kHz SCS, an interval between PRBs of a specific interlace is spaced by 5 PRBs, and a total of 5 interlace indices can be occupied. For example, interlaced RBs in interlace index 0 can be {RB 0, RB 5, RB 10, RB 15, . . . }, interlaced RBs in interlace index 1 can be {RB 1, RB 6, RB 11, RB 16, . . . }, . . . , interlaced RBs in interlace index 4 can be {RB 4, RB 9, RB 14, RB 19, . . . }.

Here, regardless of an SCS value, the number of PRBs occupied by a specific interlace can be 10 or 11.

As described above, when a PSFCH is configured with an interlace structure, a PUCCH sequence for PUCCH format 0 occupying a single PRB is repeatedly transmitted in 10 or 11 PRBs occupied by a specific interlace index, and a cyclic shift value of the repeatedly transmitted PUCCH sequence can be configured to have different values to prevent degradation of PAPR (peak to average power ratio)/CM (cubic metric) performance. Here, the cyclic shift interval introduced in NR-U (i.e., Δ=5) can be used.

In the existing sidelink communication, a PSFCH repeatedly transmits the same sequence in 2 symbols, and uses the first symbol for AGC (automatic gain control) training. A PSFCH having an interlaced structure can also be configured to always repeatedly transmit the same sequence in 2 symbols for each PRB, and use the first symbol for AGC training.

Meanwhile, in existing sidelink communication, a PSFCH slot is configured semi-statically.

FIG. 9 illustrates a method for determining a PSFCH slot in a wireless communication system to which the present disclosure can be applied.

Referring to FIG. 9, PSFCH resources are configured in a period (e.g., 1, 2, or 4 slots) configured by the higher layer parameter sl-PSFCH-Period. FIG. 9 exemplifies a case where a period of PSFCH resources is configured to 4 slots, and PSFCH resources are configured in slot n+2 and slot n+6.

A PSFCH can be transmitted in the first slot including a PSFCH resource after a predetermined time gap (configured by the higher layer parameter sl-MinTimeGapPSFCH) after the last slot of PSSCH reception. Therefore, for example, assuming that the time gap is 3 slots, since there is no PSFCH resource in slot n+3, which is 3 slots after PSSCH 1 in slot n, a PSFCH can be transmitted in response to PSSCH 1 in slot n+6, where a PSFCH resource is configured for the first time. The same can be applied to PSSCH 2 and PSSCH 3. Since a PSFCH resources is configured in slot n+6, which is 3 slots after PSSCH 4, a PSFCH can be transmitted in response to PSSCH 4 in slot n+6. Since 3 slots after PSSCH 5, PSSCH 6, and PSSCH 7 are after slot n+6, a PSFCH can be transmitted in response to the PSSCH in the slot where a PSFCH resource is configured for the first time after slot n+6.

However, in an unlicensed band/spectrum (or shared spectrum), it may be desirable for an Rx UE to transmit a PSFCH in response to a PSSCH within a channel occupancy time (COT) configured by a Tx UE. For example, in the example of FIG. 9, since a PSFCH for PSSCH 1 in slot n is transmitted in slot n+6 (since the transmission interval is large), a problem may occur in which a PSFCH within a COT may not be transmitted.

Therefore, a method of dynamically configuring/indicating slot timing of a PSFCH via a PSCCH and/or a PSSCH (e.g., by the first-stage and/or second-stage SCI) may also be considered. Here, for example, a Tx UE may provide a COT to an Rx UE or share the channel occupancy via a PSCCH and/or a PSSCH (e.g., by the first-stage and/or second-stage SCI, or by MAC CE).

If a method in which PSFCH slots are configured semi-statically (i.e., implicitly) similar to the existing operation is considered, an linkage between PSSCH slots and PSFCH slots can be locally determined only based on slots within (belonging to) a COT.

The present disclosure proposes an operation in which a Tx UE additionally dynamically configures/indicates a PSFCH slot even when there are PSFCH slots that are configured semi-statically. In other words, even if PSFCH slots (or resources) are configured semi-statically by a base station through higher layer signaling, etc., a PSFCH slot (or resource) can be configured dynamically by a Tx UE through a PSCCH and/or a PSSCH.

More specifically, if a semi-statically configured PSFCH slot (or resource) is included in a COT configured by a Tx UE, an Rx UE may ignore a PSFCH slot (or resource) dynamically configured/indicated by the Tx UE and transmit HARQ-ACK information for a PSSCH in the semi-statically configured PSFCH slot (or resource). On the other hand, if a semi-statically configured PSFCH slot (or resource) is not included in the COT configured by the Tx UE, the Rx UE may transmit HARQ-ACK information for the PSSCH in the PSFCH slot (or resource) dynamically configured/indicated by the Tx UE.

Alternatively, even if a semi-statically configured PSFCH slot (or resource) is configured, if a Tx UE additionally dynamically configures/indicates a PSFCH slot (or resource), an Rx UE can always use the dynamically configured PSFCH slot (or resource). That is, the dynamically configured PSFCH slot (or resource) can have priority over the semi-statically configured PSFCH slot (or resource). Here, if the Tx UE dynamically configures a PSFCH slot (or resource), the PSFCH slot (or resource) can always be configured/indicated to belong within the COT occupied by the Tx UE.

Resource mapping between PSSCH resources and PSFCH resources in the current sidelink is defined, and can be summarized as follows.

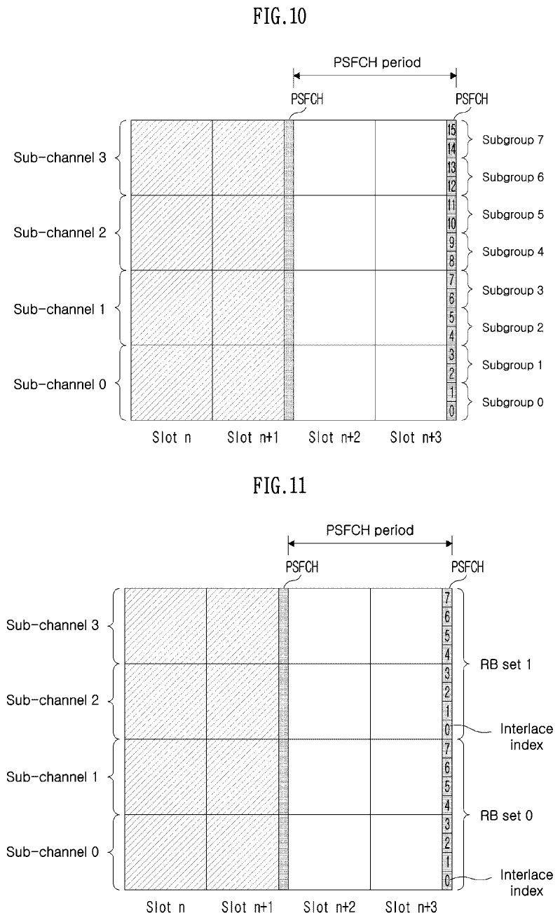

FIG. 10 is a diagram illustrating resource mapping between PSSCH resources and PSFCH resources in a wireless communication system to which the present disclosure can be applied.
1) First, an RB group for PSFCH resources can be configured (in advance) for each resource pool. For example, M (e.g., M=16) (discontinuous or continuous) RBs can be defined as an RB group for PSFCH resources. FIG. 10 illustrates an example in which an RB group for PSFCH resources is configured with 16 RBs (RBs 1 to 16 in FIG. 10) in slot n+1 and slot n+3, respectively.

Here, as described above, a period of PSFCH resources can be configured to one of 1, 2, and 4 slots (i.e., set by sl-PSFCH-Period), and when the period of PSFCH resources is configured to N slots (for example, N=2), the total number of PSSCH slots associated with one PSFCH resource becomes N slots. In FIG. 10, it is assumed that a predetermined time gap (set by the upper layer parameter sl-MinTimeGapPSFCH) is 2 slots, and the PSSCH slot associated with the RB group of PSFCH in slot n+3 is slot n, slot n+1 (total 2=PSFCH period).

In addition, assuming that the number of sub-channels, which are frequency resources constituting a PSSCH, is S (for example, S=4) in the resource pool (sub-channel indices 0 to 3 in FIG. 10), an RB group (RB 1 to 16 in FIG. 10) composed of M RBs for the PSFCH resource is divided into N*S (for example, N*S=2*4=8) sub-groups (subgroups 0 to 7 in FIG. 10). As a result, the number of RBs corresponding to each sub-group is M/(N*S) (for example, 16/(2*4)=2).

2) An operation of determining which PSFCH resource among the N*S sub-groups (subgroups 0 to 7 in FIG. 10) an RX UE can select is determined in relation to the slot index and sub-channel index of the PSSCH resource received by the RX UE. That is, the indexing of the PSSCH resource and the sub-group of the PSFCH is linked by first increasing the slot index and then increasing the sub-channel index.

For example, referring to FIG. 10, it is assumed that 2 slots (slot n, n+1) and 4 sub-channels (sub-channels 0, 1, 2, 3) are occupied by the PSSCH, and accordingly, there are 8 sub-groups for the PSFCH resource. The sub-group index 0 of the PSFCH may correspond to the first slot (slot n) & the first sub-channel (sub-channel 0) for the PSSCH, and the sub-group index 1 of the PSECH may correspond to the second slot (slot n+1) & the first sub-channel (sub-channel 0) for the PSSCH. In addition, sub-group index 2 of the PSFCH may correspond to the first slot (slot n) & the second sub-channel (sub-channel 1) for the PSSCH, and sub-group index 3 of the PSFCH may correspond to the second slot (slot n+1) & second sub-channel (sub-channel 1) for the PSSCH. In addition, sub-group index 4 of the PSFCH may correspond to the first slot (slot n) & third sub-channel (sub-channel 2) for the PSSCH, and sub-group index 5 of the PSFCH may correspond to the second slot (slot n+1) & third sub-channel (sub-channel 2) for the PSSCH. Additionally, sub-group index 6 of the PSFCH may correspond to the first slot (slot n) & fourth sub-channel (sub-channel 3) for the PSSCH, and sub-group index 7 of the PSFCH may correspond to the second slot (slot n+1) & fourth sub-channel (sub-channel 3) for the PSSCH.

3) There are two methods for selecting one or more sub-group indices according to the pre-configuration information. In the first method, a lowest sub-channel among the sub-channels allocated to the PSSCH received by the RX UE and one sub-group index for the PSFCH corresponding to the slot in which the actual PSSCH is transmitted may be selected. In the second method, one or more sub-group indices for the entire sub-channels allocated to the PSSCH received by the RX UE and the PSFCH corresponding to the slot in which the actual PSSCH is transmitted may be selected.

For example, referring to FIG. 10, if sub-channels 0 and 1 are allocated for a PSSCH and the actual PSSCH is transmitted in slot n, sub-group 0 is available for PSFCH transmission according to the first method, and sub-groups 0 and 2 are available for PSFCH transmission according to the second method.

After that, the PSFCH resource can be indexed by rearranging the PRB index and the cyclic shift pair (CS pair) index in one dimension for all PRBs corresponding to one or more selected sub-group indices. Here, it is defined to increase the PRB index first and then the CS pair index in order to perform FDM first. For example, if a total of two sub-groups are selected (i.e., the PSSCH is allocated to two sub-channels and the pre-configuring method is the second method), and if each sub-group is configured with two PRBs, a total of four PRBs can be selected. Here, if there are a total of 4 CS pair indices, index 0 of the PSFCH resource can be defined as the first PRB & first CS pair, index 1 of the PSFCH resource can be defined as the second PRB & first CS pair, index 2 of the PSFCH resource can be defined as the third PRB & first CS pair, index 3 of the PSFCH resource can be defined as the fourth PRB & first CS pair, index 4 of the PSFCH resource can be defined as the first PRB & second CS pair, index 5 of the PSFCH resource can be defined as the second PRB & second CS pair, . . . , index 14 of the PSFCH resource can be defined as the third PRB & fourth CS pair, and index 15 of the PSFCH resource can be defined as the fourth PRB & fourth CS pair.

4) Finally, which PSFCH resource among the given PSFCH resources the RX UE will select is determined based on the source ID and/or member ID (in case of group-cast HARQ-ACK feedback option 2) of the received PSSCH. Then, the RX UE selects the corresponding PSFCH resource (i.e., PRB index and CS pair index) and uses it for PSFCH transmission. Here, the source ID is a layer 1 ID of the Tx UE, which can be indicated in the 2nd-stage SCI. The member ID can be 0 for unicast HARQ-ACK feedback and group-cast HARQ-ACK feedback option 1. For group-cast HARQ-ACK feedback option 2, the member ID can correspond to an identifier of the Tx UE within the group, which can be set by higher layer signaling.

Hereinafter, the present disclosure proposes a method for determining PSFCH resources (mapping between PSSCH resources and PSFCH resources) when sidelink transmission and reception operates in an unlicensed band/spectrum (or shared spectrum).

FIG. 11 is a diagram illustrating resource mapping between PSSCH resources and PSFCH resources according to an embodiment of the present disclosure.

1) When sidelink transmission/reception operates in an unlicensed band/spectrum (or shared spectrum), an interlace PRB, instead of a single PRB, may be used as a PSFCH resource. That is, an interlaced PSFCH may be considered. In this case, in the above-described method, an RB group may be indicated by an interlace index and an RB set index instead of being indicated by the number of PRBs, and in the present disclosure, for the convenience of explanation, this may be referred to as an interlaced RB group, instead of an RB group. In addition, one PSFCH resource that can be CDMed with a CS pair may be configured to a single interlace index confined to a single RB set, rather than a single PRB.

For example, within a resource pool or within a SL BWP, an interlace index and/or an RB set index may be configured/indicated in a bitmap form and/or a resource indication value (RIV) form, respectively. That is, when X interlace indices (e.g., X=8 (#0 to #7)) and Y RB set indices (e.g., Y=2 (e.g., #1, #3)) are indicated, the number of interlace indices belonging to an interlaced RB group can be X*Y in total (e.g., X*Y=8*2=16, 8 interlace indices in RB set #1, 8 interlace indices in RB set #3). As a result, the above operation can allocate the same number of interlace indices to each RB set.

Referring to FIG. 11, an example is given where the interlace index is indicated/configured to 0 to 7 for an interlaced RB group, and the RB set index is indicated/configured to 0 and 1. Interlace indices 0 to 7 may be allocated to RB set 0 and RB set 1, respectively. As a PSFCH resource, a single interlace index belonging only to RB set 0 or 1 may be allocated/configured.

As another example, only the total number of interlace indices within the resource pool or within the SL BWP is allocated, and a method can be defined in which the lowest interlace index of the lowest RB set occupied by the sidelink BWP is selected.

For example, if M interlace indices (e.g., M=16) are allocated for a PSFCH, for 15 kHz SCS, 10 interlace indices may be used in the lowest RB set and 6 interlace indices may be used in the 2nd lowest RB set. Alternatively, for 30 kHz SCS, 5 interlace indices may be used in the lowest RB set, 5 interlace indices may be used in the 2nd lowest RB set, 5 interlace indices may be used in the 3rd lowest RB set, and 1 interlace index may be used in the 4th lowest RB set. However, the above cases are only examples according to the present disclosure, and the number of interlace indices to be used in each RB set may be configured differently.

As another example, a method of indicating one or more RB set indices within a resource pool or a SL BWP may be considered. In this case, if an interlace index is not separately indicated, all interlace indices within the indicated RB set index may be configured to be used as PSFCH resources. Alternatively, if a separate interlace index is indicated, an RB set index to which the interlace index is to be applied may be separately indicated or defined in advance.

As another example, additionally, a starting symbol index may be indicated while including the above methods. That is, a starting symbol index #N (for example, N=12) may be used/indicated, and a starting symbol index #N-x that is x symbols earlier than it may also be used/indicated. For example, when x=3, a starting symbol index #N-3 (for example, N-3=12-3=9) (or N-2 or N-4) that is 3 symbols earlier than it may be used/indicated. This is to resolve the phenomenon of insufficient resources due to the change to an interlaced structure, and may be defined with a 3-symbol gap (for example, 1 symbol may be used as an LBT (listen before talk) gap) similar to what was introduced in the initial PUCCH resource set of NR-U. If more is needed, a starting symbol index N-6 may also be considered.

2) Considering the number of sub-channels S (for example, S=4) allocated to the PSSCH and the number of slots N (for example, N=2) of the total PSSCH to be transmitted on the PSFCH at a specific point in time, the interlaced RB group for the PSFCH can be divided into S*N (for example, 4*2=8) interlaced RB sub-groups. For example, if an interlaced RB group composed of a total of 16 interlace indices is divided into 8 sub-groups, each sub-group will include 2 interlace indices.

Here, when dividing the interlaced RB group into sub-groups, it can be configured to be divided into sub-groups by sorting them by first increasing the interlace index and then increasing the RB set index. For example, in FIG. 11, it is assumed that the interlaced RB group is divided into 8 sub-groups and indexed with sub-group indexes 0 to 7. In this case, sub-group index 0 can be composed of interlace indexes 0 and 1 within RB set 0, sub-group index 1 can be composed of interlace indexes 2 and 3 within RB set 0, sub-group index 2 can be composed of interlace indexes 4 and 5 within RB set 0, and sub-group index 3 can be composed of interlace indexes 6 and 7 within RB set 0. Additionally, sub-group index 4 may be composed of interlace indices 0 and 1 within RB set 1, sub-group index 5 may be composed of interlace indices 2 and 3 within RB set 1, sub-group index 6 may be composed of interlace indices 4 and 5 within RB set 1, and sub-group index 7 may be composed of interlace indices 6 and 7 within RB set 1.

Alternatively, conversely, it can be configured to divide into sub-groups by sorting them by first increasing the RB set index and then increasing the interlace index. For example, it is assumed that the interlaced RB group in FIG. 11 is divided into 8 sub-groups and indexed with sub-group indices 0 to 7. In this case, sub-group index 0 may be composed of interlace index 0 of RB sets 0 and 1, sub-group index 1 may be composed of interlace index 1 of RB sets 0 and 1, sub-group index 2 may be composed of interlace index 2 of RB sets 0 and 1, sub-group index 3 may be composed of interlace index 3 of RB sets 0 and 1, sub-group index 4 may be composed of interlace index 4 of RB sets 0 and 1, sub-group index 5 may be composed of interlace index 5 of RB sets 0 and 1, sub-group index 6 may be composed of interlace index 6 of RB sets 0 and 1, and sub-group index 7 may be composed of interlace index 7 of RB sets 0 and 1.

And, the S*N interlaced RB sub-groups can be associated/corresponded to the slot index and sub-channel index of the PSSCH resource received by the RX UE. For example, the PSSCH resource and the indexing of the interlaced RB sub-group of the PSFCH can be associated by first increasing the slot index of the PSSCH and then increasing the sub-channel index. For example, referring to FIG. 11, it is assumed that the PSSCH occupies 2 slots (slot n, n+1) and 4 sub-channels (sub-channels 0, 1, 2, 3), and accordingly, there are 8 interlaced RB sub-groups for the PSFCH resource. Interlaced RB sub-group index 0 of the PSFCH may correspond to/be associated with/mapped to the first slot (slot n) & the first sub-channel (sub-channel 0) of the PSSCH, and interlaced RB sub-group index 1 of the PSFCH may correspond to/be associated with/mapped to the second slot (slot n+1) & the first sub-channel (sub-channel 0) of the PSSCH. In addition, interlaced RB sub-group index 2 of the PSFCH may correspond to/be associated with/mapped to the first slot (slot n) & the second sub-channel (sub-channel 1) of the PSSCH, and interlaced RB sub-group index 3 of the PSFCH may correspond to/be associated with/mapped to the second slot (slot n+1) & the second sub-channel (sub-channel 1) of the PSSCH. In addition, interlaced RB sub-group index 4 of the PSFCH may be corresponded to/associated/mapped to the first slot (slot n) & the third sub-channel (sub-channel 2) of the PSSCH, and interlaced RB sub-group index 5 of PSFCH may be corresponded to/associated/mapped to the second slot (slot n+1) & the third sub-channel (sub-channel 2) of the PSSCH. In addition, interlaced RB sub-group index 6 of the PSFCH may be corresponded to/associated/mapped to the first slot (slot n) & the fourth sub-channel (sub-channel 3) of the PSSCH, and interlaced RB sub-group index 7 of the PSFCH may be corresponded to/associated/mapped to the second slot (slot n+1) & the fourth sub-channel (sub-channel 3) of the PSSCH.

Additionally, when dividing an interlaced RB group into sub-groups, it can be configured to be divided into sub-groups by sorting them by including the starting symbol index in addition to the above interlace index and RB set index. Here, the interlace index and/or the RB set index may be configured to increase first, and the starting symbol index may be configured to increase last. Alternatively, the starting symbol index may be configured to increase first, and then the interlace index and/or the RB set index may be configured to increase. Another indexing method may also be extended and applied.

3) Thereafter, the divided interlace RB sub-group is selected as one or more interlaced RB sub-groups according to pre-configured information. In the first method, the lowest sub-channel among the sub-channels allocated to the PSSCH received by the RX UE and one interlaced RB sub-group index corresponding to the slot in which the actual PSSCH is transmitted can be selected. In the second method, the entire sub-channels allocated to the PSSCH received by the RX UE and one or more interlaced RB sub-group indexes corresponding to the slot in which the actual PSSCH is transmitted can be selected.

Afterwards, when one or more interlaced RB sub-group indices are selected, the interlace index and/or the RB set index and/or the starting symbol index, and the number of CS pair indices defined in advance for the interlaced structure included in the selected interlaced RB sub-group indices are combined and rearranged in one dimension to index the interlaced PSFCH resource.
For example, the interlaced PSFCH resource may be indexed in the order in which the RB set index increases first, then the interlace index increases next, then the starting symbol index increases next, and finally the CS pair index increases.
As another example, interlaced PSFCH resources may be indexed in the order in which the interlace index increases first, then the RB set index increases next, then the starting symbol index increases next, and finally the CS pair index increases.
As another example, interlaced PSFCH resources may be indexed in the order in which the starting symbol index increases first, then RB set index increases next, then interlace index increases next, and finally CS pair index increases.
As another example, interlaced PSFCH resources may be indexed in the order in which the starting symbol index increases first, then interlace index increases, then RB set index increases, and finally CS pair index increases.

In addition, the starting symbol index may not be included in the above proposed method, and other indexing methods may be extended and applied.

2-ra) Finally, which interlaced PSFCH resource among the given interlaced PSFCH resources the RX UE will select can be determined based on the source ID and/or member ID (in case of group-cast HARQ-ACK feedback option 2) of the received PSSCH. Then, the RX UE can select the corresponding interlaced PSFCH resource (i.e., interlace index, RB set index, CS pair index) to use for the interlaced PSFCH transmission. As described above, the source ID is a layer 1 ID of the Tx UE, and can be indicated in the 2nd-stage SCI. The member ID can be 0 for unicast HARQ-ACK feedback and group-cast HARQ-ACK feedback option 1. For group-cast HARQ-ACK feedback option 2, the member ID can correspond to an identifier of a Tx UE within the group, and can be configured by higher layer signaling.

2-na-b) Meanwhile, if a method of selecting an interlaced RB sub group based on a sub-channel index and slot index assigned to a PSSCH among the PSSCH and PSFCH mapping methods in the proposed interlace structure is considered, the RB set index and/or interlace index of the PSSCH may also be considered as a parameter for PSFCH mapping.
In the first method, after RB set indexes of the interlaced PSFCH are corresponded/associated/mapped to RB set indexes in which the PSSCH is transmitted, then the interlace indexes of the interlaced PSFCH may be corresponded/associated/mapped to interlace indexes in which the PSSCH is transmitted. Then, interlaced PSFCH starting symbol indexes or CS pair groups may be corresponded/associated/mapped to slot indexes in which the PSSCH is transmitted.
Alternatively, after the RB set indexes of the interlaced PSFCH are corresponded/associated/mapped to the RB set indexes in which the PSSCH is transmitted, then CS pair groups of the interlaced PSFCH may be corresponded/associated/mapped to interlace indexes in which the PSSCH is transmitted. Then, the interlaced PSFCH starting symbol indexes or interlace indexes may be corresponded/associated/mapped to the slot indexes in which the PSSCH is transmitted.
In another way, after CS pair groups are corresponded/associated/mapped to RB set indexes in which the PSSCH is transmitted, then interlace indexes of interlaced PSFCH can be corresponded/associated/mapped to interlace indexes in which the PSSCH is transmitted. Then, interlaced PSFCH starting symbol indexes or RB set indexes can be corresponded/associated/mapped to slot indexes in which the PSSCH is transmitted.

In addition, when additionally allocating with an interlaced structure, an interlaced structure of a sub-PRB level may be considered when available PSFCH resources are insufficient. Here, the sub-PRB level interlace index may also be used as a parameter when dividing an interlace RB group into sub-groups or when indexing interlaced PSFCH resources.

Meanwhile, in a situation where a PSSCH and a PSFCH are not shared with a COT, a situation may arise where the PSFCH cannot be transmitted due to LBT failure of an RX UE. Therefore, if an interlaced PSFCH is considered, the structure in which 1 PSFCH slot is occupied per N sidelink PSSCH slots (N is a natural number) can be expanded to a structure in which M interlaced PSFCH slots are occupied per N PSSCH slots (M is a natural number, M and N may be the same value, or may be different values.). In this case, when dividing the interlace RB group for a PSFCH into sub-groups, the slot index assigned to the PSFCH is first increased so that many interlaced PSFCHs assigned to different slots can be allocated within a specific sub-group, and then the interlace index and/or the RB set index and/or the starting symbol index are increased so that the sub-group index can be associated/corresponded/mapped.

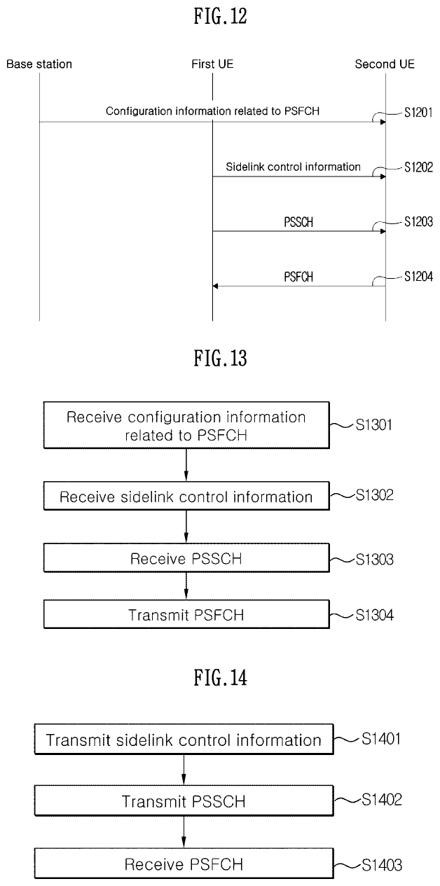

FIG. 12 illustrates a signaling procedure for a PSFCH transmission and reception method according to an embodiment of the present disclosure.

In FIG. 12, for convenience of explanation, a sidelink Tx UE is referred to as a first UE, and a sidelink Rx UE is referred to as a second UE. In addition, in FIG. 12, a sidelink operation between a first UE and a second UE may operate in an unlicensed band/spectrum or a shared spectrum.

Referring to FIG. 12, a second UE receives configuration information related to a PSFCH from a base station (S1201).

The configuration information related to a PSFCH (e.g., SL-PSFCH-Config) may be transmitted by being included in configuration information related to a resource pool for sidelink communication (e.g., SL-ResourcePool). Additionally, it may be transmitted via higher layer signaling (e.g., RRC signaling).

In addition, the configuration information related to the PSFCH (e.g., SL-PSFCH-Config) may include information on a minimum time gap (in slot units) between PSSCHs associated with the PSFCH (e.g., sl-MinTineGapPSFCH), information on a number of CS (cyclic shift) pairs used for PSFCH transmission that can be multiplexed within one PRB (or interlace PRB) (e.g., sl-NumMuxCS-Pair), and information on a period of PSFCH resources (in slot units) within the corresponding resource pool (e.g., sl-PSFCH-Period).

As described above, a slot for PSFCH transmission may be determined as the first slot (hereinafter referred to as a first slot) including PSFCH resources after a predetermined time gap (e.g., set by sl-MinTimeGapPSFCH) after the last slot of PSSCH reception from a first UE.

In addition, according to the proposed method of the present disclosure, the configuration information related to the PSFCH (e. g., SL-PSFCH-Config) may include information for configuring/indicating an interlaced RB group. For example, the interlaced RB group may be determined based on the number of interlace indices and/or the number of RB sets configured by the configuration information within a slot for transmission of the PSFCH. In addition, the interlaced RB group may be determined by further considering the number of starting symbol indices of the PSFCH.

A second UE may receive sidelink control information (SCI) (or 1st-stage SCI) from a first UE via PSCCH (S1202).

A second UE may receive a PSSCH (e.g., 2nd-stage SCI, MAC PDU, data, etc.) related to a PSCCH from a first UE (S1203).

For a specific description of steps S1202 and S1203, refer to the description of FIG. 7 above.

A second UE transmits a PSFCH containing HARQ-ACK information to a first UE in response to a PSSCH (S1204).

Here, when a first slot determined based on the configuration information is not included in a channel occupancy time (COT) for sharing the channel occupancy, a slot for transmission of a PSFCH can be determined as a specific slot (hereinafter referred to as a second slot) based on information in SCI. For example, information on the COT can be provided from a Ix UE to an Rx UE via a PSCCH and/or a PSSCH (e.g., by the first-stage and/or second-stage SCI, or by a MAC CE).

On the other hand, when a first slot determined based on the configuration information is included in the COT, a slot for transmission of a PSFCH can be determined as a first slot regardless of the information in the SCI for determining the second slot (i.e., the information in the SCI is ignored).

In addition, based on the information in SCI, a second slot can be determined to always be included in the COT. That is, the second slot can be indicated in SCI to always be included in the COT.

In addition, in determining the PSFCH resource within a slot for PSFCH transmission determined as above, the following method can be applied.

Based on the number of sub-channels allocated to a PSSCH and the number of slots of the PSSCH associated with the slot for transmission of the PSFCH, the interlaced RB group can be divided into a plurality of interlaced RB sub-groups. In addition, the plurality of interlaced RB sub-groups can be indexed using at least one of an interlace index, a resource block set index (RB set index), and a starting symbol index.

Alternatively, a plurality of PSSCH slots may be associated/corresponded to M (M>1, M is a natural number) transmittable slots of a PSFCH. In this case, an interlaced RB group may be determined within the M (M>1, M is a natural number) interlaced RB group into a plurality of interlaced RB sub-groups, the indices of the M slots may be preferentially used, and the plurality of interlaced RB sub-groups may be indexed by further using at least one of an interlace index, an RB set index, and a starting symbol index.

In addition, one or more interlaced RB sub-groups may be selected based on an index of a sub-channel allocated to a PSSCH in a plurality of interlaced RB sub-groups and a slot in which the PSSCH is transmitted. Then, a plurality of interlaced PSFCH resources are indexed using at least one of an interlace index, an RB set index, and a CS pair index within the selected one or more interlaced RB sub-groups, and the PSFCH may be transmitted in an interlaced PSFCH resource selected from among the plurality of interlaced PSFCH resources.

FIG. 13 is a diagram illustrating an operation of a UE for a PSFCH transmission and reception method according to one embodiment of the present disclosure.

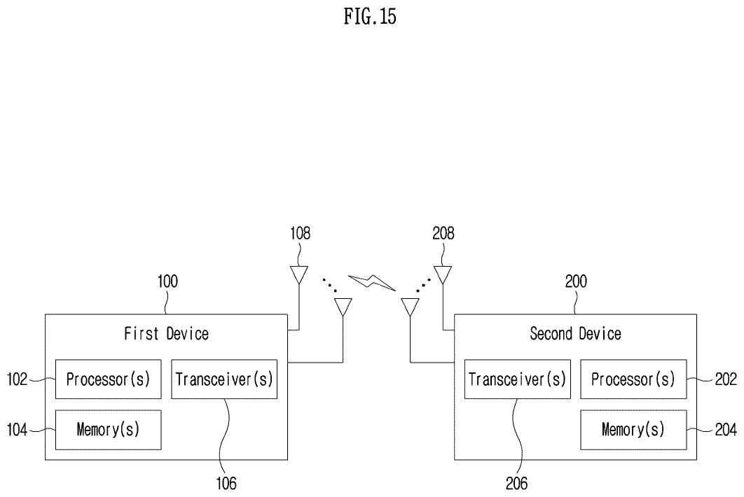

FIG. 13 illustrates an operation of a UE based on the previously proposed method. The example of FIG. 13 is provided for convenience of explanation and does not limit the scope of the present disclosure. Some step(s) illustrated in FIG. 13 may be omitted depending on circumstances and/or settings. In addition, the UE in FIG. 13 is only an example and may be implemented as a device illustrated in FIG. 15 below. For example, the processor (102/202) of FIG. 15 may control the transceiver (106/206) to transmit and receive channels/signals/data/information, etc. in the memory (104/204). In addition, the processor (102/202) of FIG. 15 may control the storage of channels/signals/data/information to be transmitted in the memory (104/204), and may control the storage of received channels/signals/data/information, etc. in the memory (104/204).

In FIG. 13, for convenience of explanation, a sidelink Tx UE is referred to as a first UE, and a sidelink Rx UE is referred to as a second UE. In addition, in FIG. 13, a sidelink operation between a first UE and a second UE may operate in an unlicensed band/spectrum or a shared spectrum.

Referring to FIG. 13, a second UE receives configuration information related to a PSFCH from a base station (S1301).

The configuration information related to a PSFCH (e.g., SL-PSFCH-Config) may be transmitted by being included in configuration information related to a resource pool for sidelink communication (e.g., SL-ResourcePool). Additionally, it may be transmitted via higher layer signaling (e.g., RRC signaling).

In addition, the configuration information related to the PSFCH (e.g., SL-PSFCH-Config) may include information on a minimum time gap (in slot units) between PSSCHs associated with the PSFCH (e.g., sl-MinTineGapPSFCH), information on a number of CS (cyclic shift) pairs used for PSFCH transmission that can be multiplexed within one PRB (or interlace PRB) (e.g., sl-NumMuxCS-Pair), and information on a period of PSFCH resources (in slot units) within the corresponding resource pool (e.g., sl-PSFCH-Period).

As described above, a slot for PSFCH transmission may be determined as the first slot (hereinafter referred to as a first slot) including PSFCH resources after a predetermined time gap (e.g., set by sl-MinTimeGapPSFCH) after the last slot of PSSCH reception from a first UE.

In addition, according to the proposed method of the present disclosure, the configuration information related to the PSFCH (e. g., SL-PSFCH-Config) may include information for configuring/indicating an interlaced RB group. For example, the interlaced RB group may be determined based on the number of interlace indices and/or the number of RB sets configured by the configuration information within a slot for transmission of the PSFCH. In addition, the interlaced RB group may be determined by further considering the number of starting symbol indices of the PSFCH.

A second UE may receive sidelink control information (SCI) (or 1st-stage SCI) from a first UE via PSCCH (S1e02).

A second UE may receive a PSSCH (e.g., 2nd-stage SCI, MAC PDU, data, etc.) related to a PSCCH from a first UE (S1303).

For a specific description of steps S1302 and S1303, refer to the description of FIG. 7 above.

A second UE transmits a PSFCH containing HARQ-ACK information to a first UE in response to a PSSCH (S1304).

Here, when a first slot determined based on the configuration information is not included in a channel occupancy time (COT) for sharing the channel occupancy, a slot for transmission of a PSFCH can be determined as a specific slot (hereinafter referred to as a second slot) based on information in SCI. For example, information on the COT can be provided from a Ix UE to an Rx UE via a PSCCH and/or a PSSCH (e.g., by the first-stage and/or second-stage SCI, or by a MAC CE).

On the other hand, when a first slot determined based on the configuration information is included in the COT, a slot for transmission of a PSFCH can be determined as a first slot regardless of the information in the SCI for determining the second slot (i.e., the information in the SCI is ignored).

In addition, based on the information in SCI, a second slot can be determined to always be included in the COT. That is, the second slot can be indicated in SCI to always be included in the COT.

In addition, in determining the PSFCH resource within a slot for PSFCH transmission determined as above, the following method can be applied.

Based on the number of sub-channels allocated to a PSSCH and the number of slots of the PSSCH associated with the slot for transmission of the PSFCH, the interlaced RB group can be divided into a plurality of interlaced RB sub-groups. In addition, the plurality of interlaced RB sub-groups can be indexed using at least one of an interlace index, a resource block set index (RB set index), and a starting symbol index.

Alternatively, a plurality of PSSCH slots may be associated/corresponded to M (M>1, M is a natural number) transmittable slots of a PSFCH. In this case, an interlaced RB group may be determined within the M (M>1, M is a natural number) interlaced RB group into a plurality of interlaced RB sub-groups, the indices of the M slots may be preferentially used, and the plurality of interlaced RB sub-groups may be indexed by further using at least one of an interlace index, an RB set index, and a starting symbol index.

In addition, one or more interlaced RB sub-groups may be selected based on an index of a sub-channel allocated to a PSSCH in a plurality of interlaced RB sub-groups and a slot in which the PSSCH is transmitted. Then, a plurality of interlaced PSFCH resources are indexed using at least one of an interlace index, an RB set index, and a CS pair index within the selected one or more interlaced RB sub-groups, and the PSFCH may be transmitted in an interlaced PSFCH resource selected from among the plurality of interlaced PSFCH resources.

FIG. 14 is a diagram illustrating an operation of a UE for a PSFCH transmission and reception method according to one embodiment of the present disclosure.

FIG. 14 illustrates an operation of a UE based on the previously proposed method. The example of FIG. 14 is provided for convenience of explanation and does not limit the scope of the present disclosure. Some step(s) illustrated in FIG. 14 may be omitted depending on circumstances and/or settings. In addition, the UE in FIG. 14 is only an example and may be implemented as a device illustrated in FIG. 15 below. For example, the processor (102/202) of FIG. 15 may control the transceiver (106/206) to transmit and receive channels/signals/data/information, etc. in the memory (104/204). In addition, the processor (102/202) of FIG. 15 may control the storage of channels/signals/data/information to be transmitted in the memory (104/204), and may control the storage of received channels/signals/data/information, etc. in the memory (104/204).

In FIG. 14, for convenience of explanation, a sidelink Tx UE is referred to as a first UE, and a sidelink Rx UE is referred to as a second UE. In addition, in FIG. 14, a sidelink operation between a first UE and a second UE may operate in an unlicensed band/spectrum or a shared spectrum.

A first UE can transmit sidelink control information (SCI) (or 1st-stage SCI) to a second UE via a PSCCH (S1401).

A first UE can transmit a PSSCH related to a PSCCH (e.g., a 2nd-stage SCI, MAC PDU, data, etc.) to a second UE (S1402).

For a specific description of steps S1401 and S1402, refer to the description of FIG. 7 above.

A first UE receives a PSFCH including HARQ-ACK information in response to a PSSCH from a second UE (S1403).

Although not shown in FIG. 14, a second UE may receive configuration information related to a PSFCH from a base station. Here, the configuration information related to a PSFCH (e. g., SL-PSFCH-Config) may be transmitted by being included in configuration information related to a resource pool for sidelink communication (e.g., SL-ResourcePool). Additionally, it may be transmitted via higher layer signaling (e.g., RRC signaling).

In addition, the configuration information related to the PSFCH (e.g., SL-PSFCH-Config) may include information on a minimum time gap (in slot units) between PSSCHs associated with the PSFCH (e. g., sl-MinTineGapPSFCH), information on a number of CS (cyclic shift) pairs used for PSFCH transmission that can be multiplexed within one PRB (or interlace PRB) (e. g., sl-NumMuxCS-Pair), and information on a period of PSFCH resources (in slot units) within the corresponding resource pool (e.g., sl-PSFCH-Period).

As described above, a slot for PSFCH transmission may be determined as the first slot (hereinafter referred to as a first slot) including PSFCH resources after a predetermined time gap (e.g., set by sl-MinTimeGapPSFCH) after the last slot of PSSCH reception from a first UE.

Here, when a first slot determined based on the configuration information is not included in a channel occupancy time (COT) for sharing the channel occupancy, a slot for transmission of a PSFCH can be determined as a specific slot (hereinafter referred to as a second slot) based on information in SCI. For example, information on the COT can be provided from a Tx UE to an Rx UE via a PSCCH and/or a PSSCH (e.g., by the first-stage and/or second-stage SCI, or by a MAC CE).

On the other hand, when a first slot determined based on the configuration information is included in the COT, a slot for transmission of a PSFCH can be determined as a first slot regardless of the information in the SCI for determining the second slot (i.e., the information in the SCI is ignored).

In addition, based on the information in SCI, a second slot can be determined to always be included in the COT. That is, the second slot can be indicated in SCI to always be included in the COT.

In addition, according to the proposed method of the present disclosure, the configuration information related to the PSFCH (e. g., SL-PSFCH-Config) may include information for configuring/indicating an interlaced RB group. For example, the interlaced RB group may be determined based on the number of interlace indices and/or the number of RB sets configured by the configuration information within a slot for transmission of the PSFCH. In addition, the interlaced RB group may be determined by further considering the number of starting symbol indices of the PSFCH.

In addition, in determining the PSFCH resource within a slot for PSFCH transmission determined as above, the following method can be applied.

Based on the number of sub-channels allocated to a PSSCH and the number of slots of the PSSCH associated with the slot for transmission of the PSFCH, the interlaced RB group can be divided into a plurality of interlaced RB sub-groups. In addition, the plurality of interlaced RB sub-groups can be indexed using at least one of an interlace index, a resource block set index (RB set index), and a starting symbol index.

Alternatively, a plurality of PSSCH slots may be associated/corresponded to M (M>1, M is a natural number) transmittable slots of a PSFCH. In this case, an interlaced RB group may be determined within the M (M>1, M is a natural number) interlaced RB group into a plurality of interlaced RB sub-groups, the indices of the M slots may be preferentially used, and the plurality of interlaced RB sub-groups may be indexed by further using at least one of an interlace index, an RB set index, and a starting symbol index.

In addition, one or more interlaced RB sub-groups may be selected based on an index of a sub-channel allocated to a PSSCH in a plurality of interlaced RB sub-groups and a slot in which the PSSCH is transmitted. Then, a plurality of interlaced PSFCH resources are indexed using at least one of an interlace index, an RB set index, and a CS pair index within the selected one or more interlaced RB sub-groups, and the PSFCH may be transmitted in an interlaced PSFCH resource selected from among the plurality of interlaced PSFCH resources.

General Device to which the Present Disclosure May be Applied

FIG. 15 is a diagram which illustrates a block diagram of a wireless communication device according to an embodiment of the present disclosure.

In reference to FIG. 15, a first wireless device 100 and a second wireless device 200 may transmit and receive a wireless signal through a variety of radio access technologies (e.g., LTE, NR).

A first wireless device 100 may include one or more processors 102 and one or more memories 104 and may additionally include one or more transceivers 106 and/or one or more antennas 108. A processor 102 may control a memory 104 and/or a transceiver 106 and may be configured to implement description, functions, procedures, proposals, methods and/or operation flow charts disclosed in the present disclosure. For example, a processor 102 may transmit a wireless signal including first information/signal through a transceiver 106 after generating first information/signal by processing information in a memory 104. In addition, a processor 102 may receive a wireless signal including second information/signal through a transceiver 106 and then store information obtained by signal processing of second information/signal in a memory 104. A memory 104 may be connected to a processor 102 and may store a variety of information related to an operation of a processor 102. For example, a memory 104 may store a software code including commands for performing all or part of processes controlled by a processor 102 or for performing description, functions, procedures, proposals, methods and/or operation flow charts disclosed in the present disclosure. Here, a processor 102 and a memory 104 may be part of a communication modem/circuit/chip designed to implement a wireless communication technology (e.g., LTE, NR). A transceiver 106 may be connected to a processor 102 and may transmit and/or receive a wireless signal through one or more antennas 108. A transceiver 106 may include a transmitter and/or a receiver. A transceiver 106 may be used together with a RF (Radio Frequency) unit. In the present disclosure, a wireless device may mean a communication modem/circuit/chip.

A second wireless device 200 may include one or more processors 202 and one or more memories 204 and may additionally include one or more transceivers 206 and/or one or more antennas 208. A processor 202 may control a memory 204 and/or a transceiver 206 and may be configured to implement description, functions, procedures, proposals, methods and/or operation flows charts disclosed in the present disclosure. For example, a processor 202 may generate third information/signal by processing information in a memory 204, and then transmit a wireless signal including third information/signal through a transceiver 206. In addition, a processor 202 may receive a wireless signal including fourth information/signal through a transceiver 206, and then store information obtained by signal processing of fourth information/signal in a memory 204. A memory 204 may be connected to a processor 202 and may store a variety of information related to an operation of a processor 202. For example, a memory 204 may store a software code including commands for performing all or part of processes controlled by a processor 202 or for performing description, functions, procedures, proposals, methods and/or operation flow charts disclosed in the present disclosure. Here, a processor 202 and a memory 204 may be part of a communication modem/circuit/chip designed to implement a wireless communication technology (e.g., LTE, NR). A transceiver 206 may be connected to a processor 202 and may transmit and/or receive a wireless signal through one or more antennas 208. A transceiver 206 may include a transmitter and/or a receiver. A transceiver 206 may be used together with a RF unit. In the present disclosure, a wireless device may mean a communication modem/circuit/chip.

Hereinafter, a hardware element of a wireless device 100, 200 will be described in more detail. It is not limited thereto, but one or more protocol layers may be implemented by one or more processors 102, 202. For example, one or more processors 102, 202 may implement one or more layers (e.g., a functional layer such as PHY, MAC, RLC, PDCP, RRC, SDAP). One or more processors 102, 202 may generate one or more PDUs (Protocol Data Unit) and/or one or more SDUs (Service Data Unit) according to description, functions, procedures, proposals, methods and/or operation flow charts included in the present disclosure. One or more processors 102, 202 may generate a message, control information, data or information according to description, functions, procedures, proposals, methods and/or operation flow charts disclosed in the present disclosure. One or more processors 102, 202 may generate a signal (e.g., a baseband signal) including a PDU, a SDU, a message, control information, data or information according to functions, procedures, proposals and/or methods disclosed in the present disclosure to provide it to one or more transceivers 106, 206. One or more processors 102, 202 may receive a signal (e.g., a baseband signal) from one or more transceivers 106, 206 and obtain a PDU, a SDU, a message, control information, data or information according to description, functions, procedures, proposals, methods and/or operation flow charts disclosed in the present disclosure.

One or more processors 102, 202 may be referred to as a controller, a micro controller, a micro processor or a micro computer. One or more processors 102, 202 may be implemented by a hardware, a firmware, a software, or their combination. In an example, one or more ASICs (Application Specific Integrated Circuit), one or more DSPs (Digital Signal Processor), one or more DSPDs (Digital Signal Processing Device), one or more PLDs (Programmable Logic Device) or one or more FPGAs (Field Programmable Gate Arrays) may be included in one or more processors 102, 202. Description, functions, procedures, proposals, methods and/or operation flow charts disclosed in the present disclosure may be implemented by using a firmware or a software and a firmware or a software may be implemented to include a module, a procedure, a function, etc. A firmware or a software configured to perform description, functions, procedures, proposals, methods and/or operation flow charts disclosed in the present disclosure may be included in one or more processors 102, 202 or may be stored in one or more memories 104, 204 and driven by one or more processors 102, 202. Description, functions, procedures, proposals, methods and/or operation flow charts disclosed in the present disclosure may be implemented by using a firmware or a software in a form of a code, a command and/or a set of commands.

One or more memories 104, 204 may be connected to one or more processors 102, 202 and may store data, a signal, a message, information, a program, a code, an instruction and/or a command in various forms. One or more memories 104, 204 may be configured with ROM, RAM, EPROM, a flash memory, a hard drive, a register, a cash memory, a computer readable storage medium and/or their combination. One or more memories 104, 204 may be positioned inside and/or outside one or more processors 102, 202. In addition, one or more memories 104, 204 may be connected to one or more processors 102, 202 through a variety of technologies such as a wire or wireless connection.

One or more transceivers 106, 206 may transmit user data, control information, a wireless signal/channel, etc. mentioned in methods and/or operation flow charts, etc. of the present disclosure to one or more other devices. One or more transceivers 106, 206 may receiver user data, control information, a wireless signal/channel, etc. mentioned in description, functions, procedures, proposals, methods and/or operation flow charts, etc. disclosed in the present disclosure from one or more other devices. For example, one or more transceivers 106, 206 may be connected to one or more processors 102, 202 and may transmit and receive a wireless signal. For example, one or more processors 102, 202 may control one or more transceivers 106, 206 to transmit user data, control information or a wireless signal to one or more other devices. In addition, one or more processors 102, 202 may control one or more transceivers 106, 206 to receive user data, control information or a wireless signal from one or more other devices. In addition, one or more transceivers 106, 206 may be connected to one or more antennas 108, 208 and one or more transceivers 106, 206 may be configured to transmit and receive user data, control information, a wireless signal/channel, etc. mentioned in description, functions, procedures, proposals, methods and/or operation flow charts, etc. disclosed in the present disclosure through one or more antennas 108, 208. In the present disclosure, one or more antennas may be a plurality of physical antennas or a plurality of logical antennas (e.g., an antenna port). One or more transceivers 106, 206 may convert a received wireless signal/channel, etc. into a baseband signal from a RF band signal to process received user data, control information, wireless signal/channel, etc. by using one or more processors 102, 202. One or more transceivers 106, 206 may convert user data, control information, a wireless signal/channel, etc. which are processed by using one or more processors 102, 202 from a baseband signal to a RF band signal. Therefor, one or more transceivers 106, 206 may include an (analogue) oscillator and/or a filter.

Embodiments described above are that elements and features of the present disclosure are combined in a predetermined form. Each element or feature should be considered to be optional unless otherwise explicitly mentioned. Each element or feature may be implemented in a form that it is not combined with other element or feature. addition, an embodiment of the present disclosure may include combining a part of elements and/or features. An order of operations described in embodiments of the present disclosure may be changed. Some elements or features of one embodiment may be included in other embodiment or may be substituted with a corresponding element or a feature of other embodiment. It is clear that an embodiment may include combining claims without an explicit dependency relationship in claims or may be included as a new claim by amendment after application.

It is clear to a person skilled in the pertinent art that the present disclosure may be implemented in other specific form in a scope not going beyond an essential feature of the present disclosure. Accordingly, the above-described detailed description should not be restrictively construed in every aspect and should be considered to be illustrative. A scope of the present disclosure should be determined by reasonable construction of an attached claim and all changes within an equivalent scope of the present disclosure are included in a scope of the present disclosure.

A scope of the present disclosure includes software or machine-executable commands (e.g., an operating system, an application, a firmware, a program, etc.) which execute an operation according to a method of various embodiments in a device or a computer and a non-transitory computer-readable medium that such a software or a command, etc. are stored and are executable in a device or a computer. A command which may be used to program a processing system performing a feature described in the present disclosure may be stored in a storage medium or a computer-readable storage medium and a feature described in the present disclosure may be implemented by using a computer program product including such a storage medium. A storage medium may include a high-speed random-access memory such as DRAM, SRAM, DDR RAM or other random-access solid state memory device, but it is not limited thereto, and it may include a nonvolatile memory such as one or more magnetic disk storage devices, optical disk storage devices, flash memory devices or other nonvolatile solid state storage devices. A memory optionally includes one or more storage devices positioned remotely from processor(s). A memory or alternatively, nonvolatile memory device(s) in a memory include a non-transitory computer-readable storage medium. A feature described in the present disclosure may be stored in any one of machine-readable mediums to control a hardware of a processing system and may be integrated into a software and/or a firmware which allows a processing system to interact with other mechanism utilizing a result from an embodiment of the present disclosure. Such a software or a firmware may include an application code, a device driver, an operating system and an execution environment/container, but it is not limited thereto.

Here, a wireless communication technology implemented in a wireless device 100, 200 of the present disclosure may include Narrowband Internet of Things for a low-power communication as well as LTE, NR and 6G. Here, for example, an NB-IoT technology may be an example of a LPWAN (Low Power Wide Area Network) technology, may be implemented in a standard of LTE Cat NB1 and/or LTE Cat NB2, etc. and is not limited to the above-described name. Additionally or alternatively, a wireless communication technology implemented in a wireless device 100, 200 of the present disclosure may perform a communication based on a LTE-M technology. Here, in an example, a LTE-M technology may be an example of a LPWAN technology and may be referred to a variety of names such as an eMTC (enhanced Machine Type Communication), etc. For example, an LTE-M technology may be implemented in at least any one of various standards including 1) LTE CAT 0, 2) LTE Cat M1, 3) LTE Cat M2, 4) LTE non-BL (non-Bandwidth Limited), 5) LTE-MTC, 6) LTE Machine Type Communication, and/or 7) LTE M and so on and it is not limited to the above-described name. Additionally or alternatively, a wireless communication technology implemented in a wireless device 100, 200 of the present disclosure may include at least any one of a ZigBee, a Bluetooth and a low power wide area network (LPWAN) considering a low-power communication and it is not limited to the above-described name. In an example, a ZigBee technology may generate PAN (personal area networks) related to a small/low-power digital communication based on a variety of standards such as IEEE 802.15.4, etc. and may be referred to as a variety of names.

A method proposed by the present disclosure is mainly described based on an example applied to 3GPP LTE/LTE-A, 5G system, but may be applied to various wireless communication systems other than the 3GPP LTE/LTE-A, 5G system.

1. A method performed in a shared spectrum by a user equipment (UE) in a wireless communication system, the method comprising:
receiving configuration information related to a physical sidelink feedback channel (PSFCH);
receiving sidelink control information (SCI) for scheduling a physical sidelink shared channel (PSSCH);
receiving the PSSCH based on the SCI; and
transmitting the PSFCH including hybrid automatic repeat request (HARQ)-acknowledgement (ACK) information in response to the PSSCH,
wherein a slot for transmission of the PSFCH is determined to be a second slot based on information in the SCI, based on a first slot determined based on the configuration information not being included in a channel occupancy time (COT) for sharing channel occupancy.

2. The method of claim 1, wherein based on the first slot determined based on the configuration information being included in the COT, the slot for transmission of the PSFCH is determined as the first slot, regardless of the information in the SCI for determining the second slot.

3. The method of claim 1, wherein based on the information in the SCI, the second slot is always determined to be included in the COT.

4. The method of claim 1, wherein an interlaced resource block (RB) group is determined based on a number of interlace indices and/or a number of RB sets configured by the configuration information within the slot for transmission of the PSFCH.

5. The method of claim 4, wherein the interlaced RB group is determined by further considering a number of starting symbol indices of the PSFCH configured by the configuration information.

6. The method of claim 4, wherein the interlaced RB group is divided into a plurality of interlaced RB sub-groups based on a number of sub-channels allocated to the PSSCH and a number of slots of the PSSCH associated with the slot for transmission of the PSFCH.

7. The method of claim 6, wherein the plurality of interlaced RB sub-groups are indexed using at least one of an interlace index, a resource block set index (RB set index), and a starting symbol index.

8. The method of claim 6, wherein one or more interlaced RB sub-groups are selected within the plurality of interlaced RB sub-groups based on an index of a sub-channel allocated to the PSSCH and a slot in which the PSSCH is transmitted.

9. The method of claim 8, wherein a plurality of interlaced PSFCH resources are indexed using at least one of an interlace index, a resource block set index (RB set index), and a cyclic shift pair index (CS pair index) within the selected one or more interlaced RB sub-groups, and
the PSFCH is transmitted in an interlaced PSFCH resource selected from among the plurality of interlaced PSFCH resources.

10. The method of claim 4, wherein the interlaced RB group is determined within M (M>1, M is a natural number) transmittable slots of the PSFCH.

11. The method of claim 10, wherein in dividing the interlaced RB group into a plurality of interlaced RB sub-groups, indices of the M slots are preferentially used, and the plurality of interlaced RB sub-groups are indexed by further using at least one of an interlace index, a resource block set index (RB set index), and a starting symbol index.

12. A user equipment (UE) operating in a shared spectrum in a wireless communication system, the UE comprising:
at least one transceiver for transmitting and receiving a wireless signal; and
at least one processor for controlling the at least one transceiver,
wherein the at least one processor configured to:
receive configuration information related to a physical sidelink feedback channel (PSFCH);
receive sidelink control information (SCI) for scheduling a physical sidelink shared channel (PSSCH);
receive the PSSCH based on the SCI; and
transmit the PSFCH including hybrid automatic repeat request (HARQ)-acknowledgement (ACK) information in response to the PSSCH,
wherein a slot for transmission of the PSFCH is determined to be a second slot based on information in the SCI, based on a first slot determined based on the configuration information not being included in a channel occupancy time (COT) for sharing channel occupancy.

13.-15. (canceled)

16. A user equipment (UE) operating in a shared spectrum in a wireless communication system, the UE comprising:
at least one transceiver for transmitting and receiving a wireless signal; and
at least one processor for controlling the at least one transceiver,
wherein the at least one processor configured to:
transmit sidelink control information (SCI) for scheduling a physical sidelink shared channel (PSSCH);
transmit the PSSCH based on the SCI; and
receive a physical sidelink feedback channel (PSFCH) including hybrid automatic repeat request (HARQ)-acknowledgement (ACK) information in response to the PSSCH,
wherein a slot for transmission of the PSFCH is determined to be a second slot based on information in the SCI, based on a first slot determined based on configuration information related to the PSFCH not being included in a channel occupancy time (COT) for sharing channel occupancy.
